(19) United States
(12) Patent Application Publication
(10) Pub. No.: US 2026/0082388 A1
(43) Pub. Date: Mar. 19, 2026

(54) ADAPTIVE SCHEDULING OF PDU SETS

(71) Applicant: InterDigital Patent Holdings, Inc., Wilmington, DE (US)

(72) Inventors: Jaya Rao, Montreal (CA); Ahmed Mostafa, Ottawa (CA); Ananth Kini, Conshohocken, PA (US); Senay Negusse, Montreal (CA); Tejaswinee Lutchoomun, Montreal (CA); Faris Alfarhan, Montreal (CA)

(73) Assignee: InterDigital Patent Holdings, Inc., Wilmington, DE (US)

(21) Appl. No.: 19/102,606

(22) PCT Filed: Aug. 8, 2023
(86) PCT No.: PCT/US2023/029741

§ 371 Date: Feb. 10, 2025

Related U.S. Application Data
(60) Provisional application No. 63/395,983, filed on Aug. 8, 2022.
(60) Provisional application No. 63/410,941, filed on Sep. 28, 2022.
(60) Provisional application No. 63/445,458, filed on Feb. 14, 2023.

(51) Int. Cl. H04W 72/21; H04L 1/1607; H04L 69/322; H04W 72/115

(52) U.S. Cl. CPC H04W 72/21; H04L 1/1614; H04L 69/322; H04W 72/115

(57) ABSTRACT

Systems, methods, and tools may schedule protocol data unit (PDU) sets. A wireless transmit receive (WTRU) may receive configuration information, including a delay threshold and a configured grant (CG) arrangement, from a network node. The WTRU may receive a first PDU subset and related information from an application. The WTRU may estimate the payload size and arrival time of a second PDU subset. Based on the estimates and the payload size of the first subset, the WTRU may determine the first and second groups of CG PUSCH occasions. If the estimated arrival time difference between the two subsets is larger than the delay threshold, the WTRU may identify an available CG PUSCH occasion. The information may be sent to the network node.

### BACKGROUND

This application claims the benefit of U.S. Provisional Application No. 63/395,983, filed Aug. 8, 2022, U.S. Provisional Application No. 63/410,941, filed Sep. 28, 2022, and U.S. Provisional application No. 63/445,458, filed Feb. 14, 2023, the contents of which are incorporated by reference herein.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities may be configured for scheduling for protocol data unit (PDU) set(s). A wireless transmit/receive unit (WTRU) may receive, from a network node, configuration information indicating a delay threshold and a configured grant (CG) configuration including a number of PUSCH occasions in a CG period. The WTRU may receive, from an application, a first subset of protocol data units (PDUs) of a PDU set and information associated with the PDU set. The PDU set may be associated with the CG period. The WTRU may determine an estimated payload size of a second subset of PDUs of the PDU set and an estimated arrival time of the second subset of PDUs of the PDU set. The WTRU may determine, based on a payload size of the first subset of PDUs and the estimated payload size of the second subset of PDUs, a first group of CG PUSCH occasions associated with the first subset of PDUs and a second group of CG PUSCH occasions associated with the second subset of PDUs. The WTRU may determine an available CG PUSCH occasion between the first and second group of CG PUSCH occasions based on an arrival time of the first subset of PDUs and the estimated arrival time of the second subset of PDUs on a condition that a difference between the estimated arrival time of the second subset of PDUs and the arrival time of the first subset of PDUs is greater than the delay threshold. The WTRU may transmit, to a network node, information indicating at least the available CG PUSCH occasion, the first group of CG PUSCH occasions, and the second group of CG PUSCH occasions.

The information associated with the PDU set may include a total payload size and a delay bound of the PDU set. The WTRU may determine, based on the total payload size and the delay bound of the PDU, the estimated payload size of the second subset of PDUs of the PDU set and the estimated arrival time of the second subset of PDUs of the PDU set.

The WTRU may estimate available CG resources based on a difference between the number of PUSCH occasions in the CG period and a sum of used PUSCH occasions in the first group and the second group of CG PUSCH occasions.

The WTRU may transmit the information in a WTRU indication that is multiplexed with the first subset of the PDU set or transmitted separately from the first subset of the PDU set.

The WTRU may assign a temporary or semi-persistent status to the available CG PUSCH occasion based on network traffic characteristics, and the temporary status may indicate applicability to a next PUSCH occasion, and a semi-persistent status may indicate applicability to one or more PUSCH occasions.

The WTRU may encode the information indicating the available CG PUSCH occasion using either a bitmap vector or an offset value. The bitmap vector may indicate a status of upcoming PUSCH occasions or slots, and the offset value may indicate a delay for the WTRU to skip PUSCH occasions.

The WTRU may receive, from the network node, an availability confirmation from the network node. The availability confirmation may indicate an approved number of PUSCH occasions to be available within the CG period.

The WTRU may transmit, to the network node, an availability indication, and the availability indication may indicate a number of available PUSCH occasions in the CG period.

Systems, methods, and instrumentalities may be configured for scheduling for protocol data unit (PDU) set(s). A wireless transmit/receive unit (WTRU may receive configuration information indicating a delay threshold and a configured grant (CG) configuration. The WTRU may determine, based on a payload size of a first subset of PDUs and an estimated payload size of a second subset of PDUs, a first group of CG PUSCH occasions associated with the first subset of PDUs and a second group of CG PUSCH occasions associated with the second subset of PDUs, The first group of CG PUSCH occasions and the second group of CG PUSCH occasions may be in a CG period from the CG configuration. The first subset of PDUs and the second subset of PDUs may include a PDU set associated with the CG period. The WTRU may determine an available CG PUSCH occasion between the first and second group of CG PUSCH occasions based on an arrival time of the first subset of PDUs and an estimated arrival time of the second subset of PDUs on a condition that a difference between the estimated arrival time of the second subset of PDUs and the arrival time of the first subset of PDUs is greater than the delay threshold. The WTRU may transmit, to a network node, information indicating at least the available CG PUSCH occasion, the first group of CG PUSCH occasions, and the second group of CG PUSCH occasions.

A wireless transmit/receive unit (WTRU) may support adaptive scheduling for protocol data unit (PDU) set(s). For example, the WTRU may determine a resource grant type to use for transmitting PDU set(s) based on a PDU set payload size threshold. For example, the WTRU may receive a total PDU set payload size threshold value. The threshold value may indicate a minimum threshold for total PDU set payload size that can be sent with configurated grant (CG) resources. The WTRU may compare a PDU set payload size to the minimum threshold. Based on a condition that the PDU set payload size is less than the minimum threshold, dynamic grant (DG) may be used as the resource grant type for sending the PDU set. Based on a condition that the PDU set payload size is no less than the minimum threshold, the WTRU may determine to use CG as the resource grant type for sending at least a portion of the PDU set.

The WTRU may receive a first configured grant configuration and a second configured grant configuration. The second configured grant configuration may use any of a lower transmit power than the first configured grant configuration and a fewer number of physical resource blocks than the first configured grant configuration. The WTRU may transmit a first portion of a PDU set with a first configured grant configuration, and the PDU set may have a delay budget. The WTRU may estimate a latency associated with transmitting a second portion of the PDU set with the second configured grant configuration. The WTRU may transmit the second portion of the PDU set with the second configured grant configuration on the condition that the estimated latency is within the delay budget.

The WTRU may transmit the second portion of the PDU set with the first configured grant configuration on the condition that the estimated latency is outside the delay budget. The second portion may include PDUs of the PDU set not included in the first portion of the PDU set. The WTRU may be associated with a low power mode when the second configured grant configuration is transmitted.

The WTRU may receive a negative acknowledge (NACK) threshold, and a number of NACKs reaching the NACK threshold may correspond to the WTRU switching to the low power mode.

In examples, WTRU may support adaptive scheduling of PDU sets. Such WTRU may be configured to perform one or more of the following: the WTRU may send assistance and/or status information associated with handling XR traffic and PDU sets; the WTRU may receive configuration and/or assistance information; the WTRU may trigger events and/or conditions during data transmissions and/or receptions; the WTRU may determine a resource grant type to use for transmitting PDU sets in UL; the WTRU may determine adjustments to CG resources based on variable PDU characteristics in a PDU set; the WTRU may determine to skip one or more CG occasions based on a determination of jitter in UL XR traffic; the WTRU may determine whether to use a CG configuration associated with higher reliability based on the status of a PDU set transmission; and/or the WTRU may determine to use SR resources associated with different LCHs according to a change in priority of PDUs in a PDU set.

An example WTRU may be configured to receive a default CG resource configuration information, a minimum threshold, and/or a maximum threshold. A first PDU of a PDU set may be received, for example, from an application layer. A PDU set information may be received. The PDU set information may include a PDU set payload size and/or a PDU set delay budget. A resource grant type for sending the PDU set may be determined based on the PDU set information, the CG resource configuration information, the minimum threshold, and/or the maximum threshold. For example, the PDU set payload size may be compared to the minimum threshold. Based on a condition that the PDU set payload size is less than the minimum threshold, a scheduling request (SR) request and a buffer status report (BSR) request for a dynamic grant (DG) may be sent. Based on a condition that the PDU set payload size is less than the minimum threshold, the PDU set may be sent using a single-shot DG transmission. Based on a condition that the PDU set payload size is less than the minimum threshold, an indication that CG occasions may not be used for transmitting the PDU set (e.g., an indication to avoid using the CG occasions for transmitting the PDU set) may be sent.

An expected latency of sending the PDU set may be determined based on the default CG resource configuration information and/or the PDU set payload size. For example, the expected latency may be compared with the PDU set delay budget. Based on a condition that the PDU set payload size does not exceed the maximum threshold and the expected latency is less than the PDU set delay budget, the PDU set may be sent using the CG resources in one or more CG occasions.

A number of excess CG occasions may be determined based on the PDU set delay budget and/or the default CG resource configuration information. A payload size that can be sent over remaining CG occasions may be determined based on the PDU set delay budget and/or the default CG resource configuration information. The number of excess CG occasions may be sent. A request for DG to send additional PDUs may be sent. A DCI may be monitored. Based on the DCI, information about allocated DG resources may be determined. The PDU set may be sent using CG and DG resources.

An example wireless transmit/receive unit (WTRU) may be configured to receive a default CG resource configuration (including, e.g., a number of PUSCH slots per occasion, a periodicity, and a number of occasions), a minimum threshold and a maximum threshold describing a total payload size that can be sent with the default CG resource configuration, a remaining latency threshold for CG configuration switching, and a retransmission threshold per PDU for supporting adaptive scheduling. A first PDU associated with a PDU set may be received. PDU set information (e.g., a PDU set payload size and a PDU set delay budget) may be received. Such WTRU may determine a resource grant type (e.g., DG, CG, or CG+DG) for sending the PDU set based on the PDU set information, the default CG resource configuration, the minimum threshold, and the maximum threshold.

In examples where the PDU set payload size does not exceed the minimum threshold, such WTRU may send SR and/or BSR requests for a DG. Such WTRU may send the PDU set using a single-shot DG transmission. Such WTRU may indicate that CG occasions associated with the default CG resource configuration will not be used for transmitting the PDU set. In examples, such WTRU may send explicit information about the PDU set delay budget. In examples, such information about the PDU set delay budget may be implicit to a XR application type. Such information may be used to allocate DG PUSCH slots before a PDU set delay deadline. Advantageously, by sending a request for a single-shot DG, such WTRU may save transmit power by sending the PDU set over DG PUSCH slots that are fewer than PUSCH slots of a single CG occasion.

In examples where the PDU set payload size meets or exceeds the minimum threshold, the WTRU may determine an expected latency associated with sending the PDU set based on the default CG resource configuration and the PDU set payload size. In such examples where the PDU set payload size does not exceed the maximum threshold and the expected latency is less than the PDU set delay budget, such WTRU may send the PDU set using CG resources in one or more CG occasions.

The WTRU may determine, based on the PDU set delay budget and the default CG resource configuration, a number of excess CG occasions and a payload size that can be sent over remaining CG occasions. Such WTRU may indicate the number of excess CG occasions. Such WTRU may send a request for DG (e.g., via SR and/or BSR) resource allocation. Such WTRU may monitor DCI for information about allocated DG resources. Upon receiving allocated DG resources, such WTRU may send the PDU set using CG and DG resources.

An example WTRU may be configured to receive a configuration information, a remaining latency threshold for CG configuration switching, and a retransmission threshold per PDU for supporting adaptive scheduling. Such configuration information may include a first CG configuration (e.g., low reliability: high modulation and coding scheme (MCS) and low number of physical resource blocks (PRBs)) and a second CG configuration (e.g., high reliability: low MCS and high number of PRBs). One or more PDUs associated with a PDU set and an indication of a PDU set delay budget may be received. The WTRU may select the first CG configuration for sending the PDUs. In the case of retransmission, the WTRU may use the first CG configuration until reaching the retransmission threshold. In examples where the retransmission threshold is exceeded (e.g., the WTRU receives a NACK after the retransmission threshold is reached), the WTRU may determine a remaining latency based on the PDU set delay budget on time spent on retransmissions. In examples where the remaining latency is less than the remaining latency threshold, the WTRU may select the second CG configuration for transmitting remaining PDUs associated with the PDU set. In examples, the WTRU may send an indication (e.g., in MAC CE or UCI or UCI+PUSCH) indicating switching or requesting to switch to the second CG configuration. In examples where the retransmission threshold is not exceeded, the WTRU may continue using first CG configuration for transmitting remaining PDUs associated with the PDU set.

A WTRU may be configured to update the resource grant type to use for transmitting PDU sets in UL. The WTRU may be configured to indicate unused UL CG occasions based on traffic characteristics. The WTRU may be configured to indicate unused UL CG occasions based on HARQ feedback. The WTRU may be configured to receive HARQ feedback for XR data transmitted using CG resources. The WTRU may be configured to switch between using single and multiple CDRX configurations.

Features described herein may be associated with a CG Configuration for enhanced power saving in XR. A WTRU may determine whether to use a CG config with a high (e.g., higher) energy efficiency (e.g., low transmit power, low number of PRBs) based on the status of a PDU set transmission (e.g., a PDU set delay budget) and a WTRU power state.

A WTRU may be configured to do the following. A WTRU may be configured to receive configuration information from a gNB, including a first CG config (e.g., default: high number of PRBs, high transmit power) and a second CG config (e.g., low power: low number of PRBs, low transmit power). The WTRU may receive a threshold for a NACK counter to enable switching to a low-power CG config. The WTRU may be configured to receive PDUs associated with a PDU set and an indication of the PDU set delay budget from the application. The WTRU may be configured to select the first CG config for sending the PDUs. The WTRU may keep using the first CG config. The WTRU may be configured to select one of the CG configs (e.g., default or low power) for further transmissions based on a PDU set delay budget and a NACK counter threshold.

If a number of NACKs received is less than a NACK counter threshold within a period of time, or if the WTRU is in a low-battery level state, the expected latency for transmitting the remaining PDUs of the PDU set using the second CG config may be determined (e.g., by the WTRU). If an expected latency is less than a PDU set delay budget, a second CG config for transmitting the remaining PDUs of PDU set may be selected (e.g., by the WTRU). Use of the first CG config for transmitting the remaining PDUs of PDU set may be continued.

In an example, a CG configuration may include enhanced power savings in XR. A WTRU may determine whether to use a CG configuration with higher energy efficiency (e.g., low transmit power, low number of PRBs) based on the status of a PDU set transmission (e.g., PDU set delay budget) and a WTRU power state.

An example WTRU may be configured to do the following. The WTRU may receive configuration information from a gNB, including a first CG configuration (e.g., default: high number of PRBs, high transmit power) and a second CG configuration (e.g., low power: low number of PRBs, low transmit power). The WTRU may also receive a threshold for a NACK counter to enable switching to a low-power CG configuration. The WTRU may receive PDUs associated with a PDU set and an indication of the PDU set delay budget from the application. The WTRU may select the first CG configuration for sending the PDUs. The WTRU may keep using the first CG configuration. The WTRU may select one or more of the CG configurations (default or low power) for further transmissions based on a PDU set delay budget and NACK counter threshold. If a number of NACKs received may be less than a NACK counter threshold within a period of time, or the WTRU may be in a low-battery level state), the WTRU may determine the expected latency for transmitting the remaining PDUs of the PDU set using the second CG configuration. If the expected latency is less than the PDU set delay budget, the WTRU may select a second CG configuration for transmitting the remaining PDUs of the PDU set. The WTRU may continue using the first CG configuration for transmitting the remaining PDUs of PDU set.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of determining a resource grant type to use for transmitting one or more packet data unit (PDU) sets.

FIG. 3 illustrates an example message flow diagram of determining changes to an adjustable CG configuration based on variable PDU characteristics in a PDU set.

### DETAILED DESCRIPTION

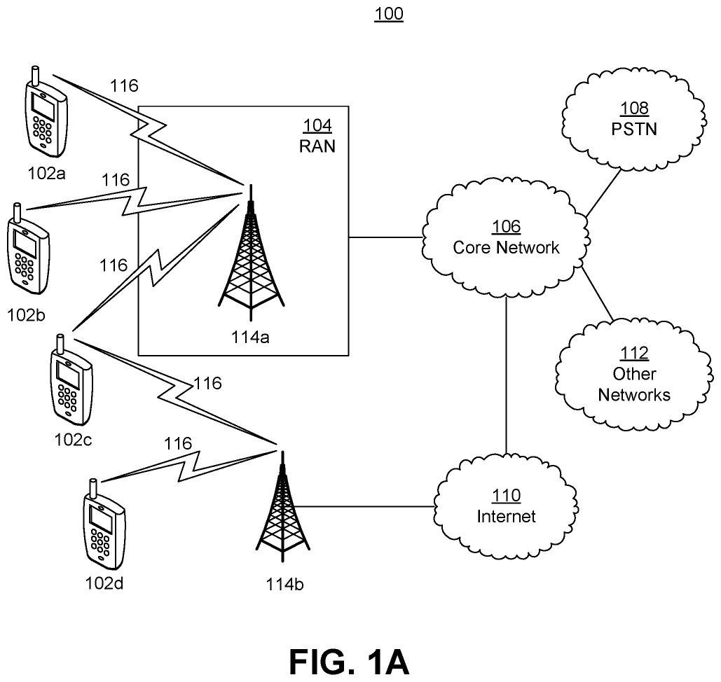

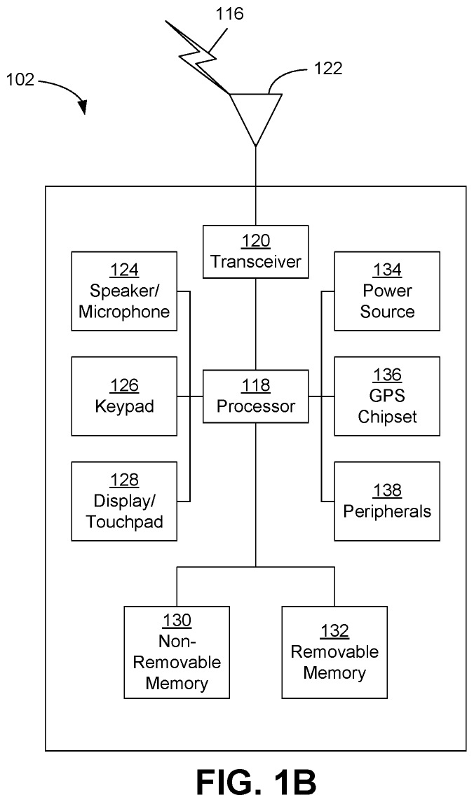

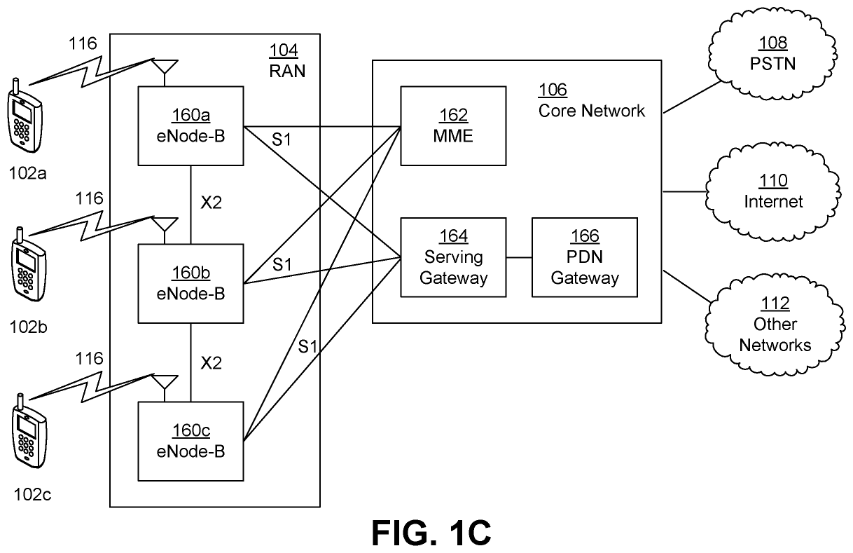

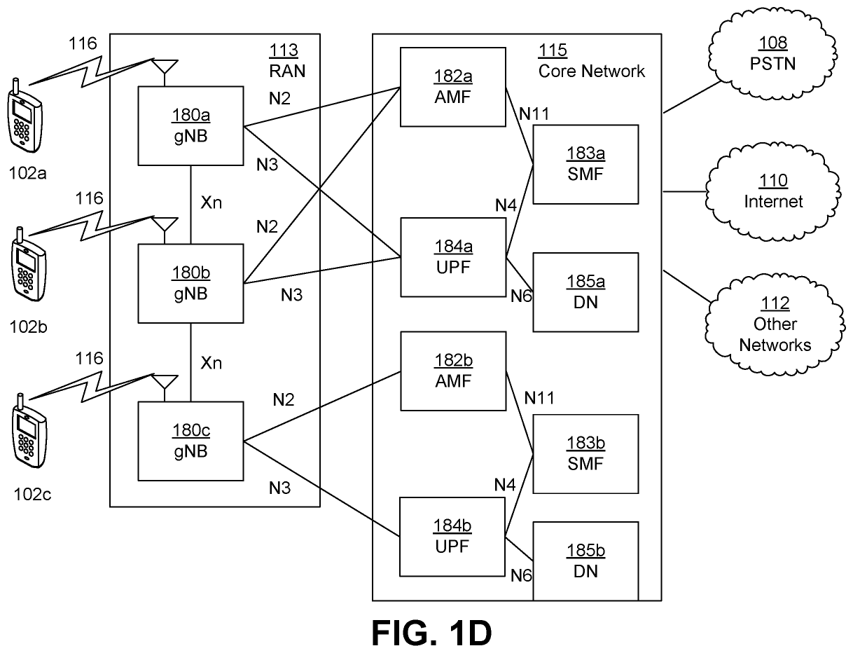

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTls) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following acronyms and/or abbreviations may be used herein:
6DOF 6 Degrees of Freedom
ACK Acknowledgement
AR Augmented Reality
AS Access stratum
BWP Bandwidth Part
BSR Buffer status report
CSI Channel State Information
CG Configured grant
DL Downlink
DMRS Dedicated Demodulation Reference Signals
DCI Downlink Control Channel
FDD Frequency Division Duplex
FoV Field of View
gNB NR Node B
FPS Frames per second
HARQ Hybrid Automatic Repeat reQuest
iBLEr initial BLock Error Rate
LCP Logical control prioritization
LCH Logical Channel
MAC Medium access control
MCS Modulation and Coding Scheme
MTP Motion-to-photon
NAS Non-access stratum
NACK Negative Acknowledgement
NW Network
PDB Packet Delay Budget
PDCCH Physical Downlink Control Channel
PDCP Packet data convergence protocol
PER Packet Error Rate
PHY Physical layer
PSG Power Saving Gain
PSR Packet Success Rate
PUCCH Physical Uplink Control Channel
PUSCH Physical Uplink Shared Channel
PDSCH Physical Downlink Shared Channel
RLO Radio link control
RTT Round trip time
SDAP Service data adaptation protocol
SR Scheduling Request
STD STandard Deviation
TDD Time Division Duplex
UCI Uplink control channel
UE User Equipment
UL Uplink
VR Virtual Reality
XR Extended Reality

As used herein, the term “extended Reality” (XR) can refer to any of several different types of immersive experiences including Virtual Reality (VR), Augmented Reality (AR) and Mixed Reality (MR), and the realities interpolated among them. Virtual Reality (VR) is a rendered version of a delivered visual and audio scene. Such rendering may mimic visual (e.g., stereoscopic 3D) and/or audio sensory stimuli of the natural world to an observer or user as they navigate the boundaries defined by a VR application. Augmented Reality (AR) is when a user is provided with, for example, supplemental information and/or artificially generated items and/or content overlaid upon a current natural environment. Mixed Reality (MR) is an advanced form of AR where one or more virtual elements are inserted into (e.g., by visual overlay) a natural scene such that one or more of these elements may be perceived as part of the natural scene. XR may include natural-and-virtual combined environments and human-machine interactions generated by computer technology and wearables.

The notion of “immersion” in the context of XR applications/services may refer to a sense of being surrounded by the virtual environment and/or a sense of being physically and spatially located in the virtual environment. The levels of virtuality may range from partial sensory inputs to fully immersive multi-sensory inputs producing to a virtual reality practically indiscernible from natural reality.

XR devices may be equipped with one or more of various sensors. Such sensors may include cameras or camera arrays (e.g., monocular and/or stereo and/or depth cameras), radio beacons, GPS receivers, inertial sensors, etc. Spatial tracking may be performed at different granularities, in some examples at 3 degrees of freedom (e.g., rotational motion along an X, a Y and a Z axis), in some examples at 6 degrees of freedom (e.g., rotational and/or translational motion along an X, a Y and a Z axis). Such special tracking may provide an interface for a user interact with virtual elements within an extended reality scene. For example, actions and/or interactions may involve movements, gestures, eye tracking, etc. For further example, some form of head and/or motion tracking may determine that virtual visual and/or audio elements may be updated in response a user's movements. Imprecise and/or delayed spatial tracking may lead to sensations of discomfort and/or motion sickness for a user.

In examples described herein, a wireless transmit/receive unit (WTRU) may correspond to any XR device and/or node and may take any of a variety of form factors. Typical WTRUs may include, but are not limited to the following: Head Mounted Displays (HMD), optical see-through glasses and camera see-through HMDs for AR and MR, mobile devices with positional tracking and camera, wearables, etc. Further types of XR WTRU may be envisioned based on XR device functions, for example devices incorporating any or several of the following: displays, cameras, sensors, sensor processing components, wireless connectivity components, XR/Media processing units, and power supplies. Such envisioned XR WTRU types may be embodied in one or more devices, wearables, actuators, controllers, and/or accessories. In examples, one or more device and/or nodes and/or WTRUs may be grouped into a collaborative XR system for supporting various XR applications and/or experiences and/or services.

In an example communication network, quality of service (QoS) may be enforced at a per-flow granularity, in which a QoS flow may be identified with a QoS flow identifier (QFI). A QFI may be associated one or more QoS parameters such as traffic type (e.g., non-guaranteed bitrate, guaranteed bitrate, or delay-critical bitrate), data rate (e.g., guarantee flow bitrate or maximum flow bitrate), packet delay budget, averaging window, maximum data burst volume (MDBV), survival time, etc. Such QoS parameters may be applied to determining forwarding treatment during transmission of packet data units (PDUs) in a data flow.

In XR services and/or applications (e.g., AR, VR, and configured grant), data traffic may include one or more PDUs, which may be associated with one or more PDU sets. The one or more PDUs belonging to a PDU set may be associated with one another based on certain application logic (e.g., by a PDU's spatial position in the frame). For example, a one or more PDUs in a PDU set may carry data associated with field of view (FoV) spatial positions in a frame. Likewise, one or more PDUs in a PDU set may carry non-FoV spatial positions in a frame. Various PDUs in a PDU set may contribute to various aspects of user experience and as such may be associated with different spatial and/or temporal saliency values. Thus, various PDUs associated with a PDU set may be differentiated and so handled differently during QoS-aware scheduling. Such differentiation may not be associated with whether one or more PDUs in a PDU set are in one or more associated QoS flows during transmission.

The QoS may be determined at a PDU set level (e.g., PDU set level delay bound, PDU set level reliability). Relative QoS associated with the PDUs (e.g., maximum delay difference achievable for the different PDUs of a PDU set) may be determined, in addition to meeting the absolute QoS requirement of the individual PDUs, during transmission in UL and DL. QoS requirements (e.g., latency and reliability) of the PDU sets associated with an XR services may be met via scheduling during transmissions. Information related to XR traffic patterns and PDU set characteristics may be provided to the gNB for enabling adaptive scheduling.

XR service and traffic characteristics are provided. As described herein, a “communication network” or “network” may include any of a base station (e.g., an NR Node B, a TRP, a radio access network node, or an access node), a core network function (e.g., an Access and Mobility Management Function), and an application function (e.g., an edge server function or a remote server function).

As described herein, “data flows” may correspond to QoS flows (e.g., one or more flows of data including one or more PDUs or PDU sets, which PDUs or PDU sets may be associated with one or more QoS parameters, such QoS parameters including e.g., latency, data rate, reliability, or round-trip time latency). Different flows (for example those flows originating from a common application and/or experience source, or those flows intended to a common destination WTRU or group of associated WTRUs) may be referred to associated flows or correlated flows.

As described herein, “forwarding configuration” may correspond to any of the following: radio bearers (e.g., data radio bearers (DRBs) and/or signaling radio bearers (SRBs)), logical channels (LCHs), logical channel groups (LCGs), configuration parameters corresponding to various layers within an access stratum (AS) protocol stack (e.g., service data adaptation protocol (SDAP), packet data convergence protocol (PDCP), radio link control, media access control, etc.), parameters associated with logical channel prioritization (LCP) (e.g., priority, policy-based routing, etc.), bandwidth parts (BWPs), carriers, radio links and/or interfaces (Uu links, SLs), and radio resources (e.g., a set of one or more frequency and/or time and/or spatial resources such as timeslots, subcarriers, or beams). Radio resources may be associated with configurated grants (CG), dynamic grants (DG) and/or any other resource grants or grant-free resources.

As described herein, “mapping configuration” may correspond to any of the following: parameters and/or configurations associated with mapping from one or more application data flows, QoS flows to one or more radio bearers, SDAP, PDCP, LCHs, carriers or component, BWPs, and radio links and/or interfaces, which may be used for delivering PDUs in upload direction or download direction.

Descriptions of XR-aware and/or application-aware data transmissions and/or receptions, as well as XR-aware QoS handling and/or application-aware QoS handling are provided. For example, a PDU set (e.g., media unit, video frame) may comprise of one or more PDUs. An PDU set may be associated with PDU set-level QoS requirements (e.g., data rate, latency, error rate, reliability), which may be applicable for one or more PDUs associated with a PDU set. One or more PDUs in a PDU set may be associated with individual PDU-level QoS requirements. Such associations and inter-dependencies may be visible to AS layers (e.g., with associated IDs) and/or handled in AS layers with the awareness of the association during data transmission in UL and reception in DL.

In examples, one or more PDUs in a PDU set may be associated with application and/or high layer importance and/or priority values. Such values may correspond for example to spatial importance (e.g., spatial position of a video frame whose data is carried in full or in part by one or more PDUs, wherein one or more PDUs carrying FoV spatial positions may be associated with higher spatial importance than those carrying non-FoV spatial positions) or for example to temporal importance (e.g., time sequence of a video frame who data is carried by the one or more PDUs, where one or more of such PDUs carrying base video frames, such as I-frames, may be associated with higher temporal importance than one or more of such PDUs carrying differential video frames, such as P-frame/B-frame). In examples, such importance values may be visible to AS layers (e.g., through associated IDs, markers, or indications). In examples, such importance values may be enabled by application awareness.

In examples, one or more PDUs in a PDU set may be encoded and delivered to a WTRU or to a network via one or more data flows. In such examples, the one or more QoS flows carrying one or more PDUs and/or PDU sets associated to an XR application and/or experience may be visible to AS layers (e.g., with associated IDs) and/or handled in AS layers with an awareness of the association during data transmission and reception.

As used herein, example characteristics of “PDUs” and “PDU sets” are provided. A PDU set may include one or more PDUs. PDUs within a PDU set may have varied payload sizes and/or varied priority values. PDUs within a PDU set may have dependency among one another. PDUs in a PDU set may have joint QoS requirements (e.g., PDU set delay bound, PDU set error rate, PDU set throughput). PDU sets may be characterized by intra-PDU set dependencies (e.g., varying importance among PDUs, and/or presence of redundant PDUs), and inter-PDU set dependencies (e.g., subsequent PDU sets may be similar to or different from previous PDU sets). PDUs and/or PDU sets may be characterized by jitter and/or non-integer periodicity values (e.g., PDU set generation rate may typically correspond to a video frame generation rate at, for example, 60 or 120 frames per second). PDUs and/or PDU sets may be characterized by variable periodicity values (e.g., a video encoder may vary frame generation rate during runtime).

As used herein, example “WTRU actions,” (e.g., actions related to application actions, or to AS layer actions such as those supporting differentiated QoS) are provided. For example, a WTRU action could involve determining metadata. Such a WTRU action could include determining metadata involving spatial perimeters (e.g., 2D/3D size, border, spatial attributes, boundaries of FoV) based on measurements in one or more spatial dimensions (e.g., longitude, latitude, altitude, depth, roll, pitch, yaw) in one more coordinate systems (e.g., cartesian, spherical). Another such WTRU action could include determining metadata associated with quality of FoV content, e.g., whether the FoV content is of high quality (e.g., in the case of an image, quality may be determined by measures such as image resolution as described, for example, by a number of density of megapixels). Another such WTRU action could include determining metadata associated with importance and/or priority of FoV content. Such importance and/or priority may be associated with spatial importance and/or temporal importance of data. To illustrate, an importance value may indicate absolute or relative importance associated with FoV content. Spatial importance may be associated with one or more segments, tiles, slices, or positions of FoV in spatial dimension. Temporal importance may be associated with one or more frames and/or subframes of FoV in time dimension.

In examples, a WTRU action could involve determining or generating application content. Such a WTRU action could involve determining and/or capturing one or more 2D and/or 3D images and/or video frames associated with an FoV boundary corresponding to FoV metadata of the WTRU for itself and/or on behalf of another WTRU. For example, FoV content mapping may involve the WTRU generating one or more image and/or video frames using visual sensors (e.g., 2D and/or 3D camera, lidar), RF sensors (e.g., RF transceiver, RADAR), audio sensors (e.g., sonar), etc. As described herein, FoV content mapping may also be referred to as sensing of FoV content or capturing of FoV content. Another such WTRU action could involve recording and/or capturing one or more audio frames, either as part of a physical environment or as part of an overlaid audio file (e.g., an audio file originating from a source other than a physical environment being mapped).

In examples, a WTRU action could involve measuring and/or reporting. Such a WTRU action could involve measuring a pose (e.g., as expressed as a one or more descriptions of 6DoF orientation, location, or position) or a rate of motion of a WTRU and/or other objects (e.g., virtual or physical) which the user may interact with. Such WTRU may transmit such pose measurements to a network, for example periodically or when triggered (by, e.g., determine change in pose measurements above or below a threshold). Another such WTRU action could involve measuring one or more of reference radio signals (e.g., a 5G NR Synchronization and Signal Block or a 5G downlink positioning reference signal), GPS signals, ultra-wideband signals, LIDAR signals, visual signals, etc. Another such WTRU action could involve measuring of radio link interfaces associated with the WTRU (e.g., Uu link, SL). For example, a WTRU trigger transmission and/or measurement of reference signals in other one or more WTRUs (e.g., via Uu link and/or sidelink). Another such WTRU action could involve transmitting a report of measurements to a network and/or another WTRU.

In examples, a WTRU action could involve handling and/or forwarding of data (e.g., PDUs and PDU sets) and handling QoS corresponding to PDUs and/or PDU sets. For such example WTRU actions, data may include media, image, or video frames, sensor data, or measurement data (e.g., pose measurements or link and/or channel measurements). Such data may support an application, service, and/or network request associated with the WTRU. Such a WTRU action could involve a WTRU sending and/or receiving data, to and/or from one or more destinations including RAN nodes (e.g., gNB), CN functions and/or entities, application functions (e.g., hosted in a WTRU or in a network), etc. Another such WTRU action could involve a WTRU splitting and/or merging data (e.g., PDUs) in one or more QoS flows into one or more forwarding configurations during transmission and/or receptions.

In examples, a WTRU action could involve a WTRU handling and/or forwarding of information related to connectivity with a network and/or one or more other WTRUs. Such a WTRU action could involve transmitting capability information to a network, such information including one or more of capability for supporting one or more interfaces, capability to coordinate and/or interact with other WTRUs (e.g., via SL interfaces) which may be co-located or non-co-located with the WTRU. Another such WTRU action could involve receiving configuration information, such as receiving RRC configuration from gNB and/or NAS-layer configuration from CN. Another such WTRU action could involve sending and/or receiving assistance data associated with traffic, QoS, scheduling, etc., to and/or from a network (e.g., for supporting UL/DL transmissions). Another such WTRU action could involve sending requests for radio resources and/or resource grants (e.g., dynamic grants, semi-static grants, or configured grants).

PDUs and/or PDU sets received in one or more QoS flows may be mapped to one or more forwarding configurations using mapping configurations. Such forwarding configurations may be configured to target and/or enforce various QoS parameters when transmitting PDUs and/or PDU sets. In an example, the PDUs of a PDU set received in one or more QoS flows may be mapped using a mapping configuration (e.g., at SDAP) to one or more forwarding configurations (e.g., DRBs with common or different PDCP entities). In examples, forwarding configurations may be associated for targeting and/or ensuring PDU set-level QoS. Upon mapping, such configurations may be applied to PDUs and/or PDU sets associated with the forwarding configuration.

In examples, it is possible that one or more PDUs of various PDU sets be received in different QoS flows, which may have different QoS parameters. Based on a determination of expected QoS for PDUs and/or PDU sets received or to be received in QoS flows, the WTRU may apply certain mapping and buffer management mechanisms at one or more layers of the AS layer protocol stack (e.g., SDAP, PDCP, MAC) such that a provided QoS for the PDUs may be satisfied during transmission and/or upon reception at a network. A similar approach may be applied when a WTRU expects to receive the PDU/PDU sets in DL from the network.

In examples, various layers in a forwarding configuration may be configured with different configuration parameters for satisfying QoS parameters of PDUs and/or PDU sets. Such configuration parameters may include support for AM/UM in RLC, LCP rules/restrictions and associated LCH parameters (e.g., PBR, BSD, priority) at MAC, and number of hybrid automatic repeat request (HARQ) transmissions, for example. In some examples, satisfying QoS parameters may require that certain configuration parameters be set in the PDCP sublayer (e.g., sequence number size and ROCH parameters) or the SDAP sublayer (e.g., a mapping of QFI and radio bearers).

As used herein, the term “expected QoS” may be used to denote an expected margin of a QoS metric (e.g., latency, data rate, reliability) before the arrival of PDUs and/or PDU sets or when the PDUs/PDU sets are received at a WTRU (e.g., for QoS to be targeted and/or enforced on transmission). For example, expected QoS may correspond to a time duration available to a WTRU for forwarding PDUs on a Uu link. For example, expected QoS may correspond to a time-to-live (TTL) (e.g., maximum time available for processing and delivering) for an individual PDU or for one or more PDUs in an PDU set. In such a case, expected QoS may be determined based on indications and/or markers in the one or more PDUs (e.g., QFI, timestamps, PDU set ID, etc., in the PDU header) and/or based on usage of timers which may be started when receiving PDUs/PDU sets and stopped at the expiry of a configured time duration. In examples, similar mechanisms may be applied for changing between different mapping and/or forwarding configurations for ensuring expected QoS.

In examples, an expected QoS may be stricter or relaxed than a default QoS metric associated with PDUs and/or PDU sets. For example, a PDU may arrive late at a WTRU (e.g., having experienced delay and/or jitter at an application layer) or the importance value of a PDU may be determined high (e.g., above a threshold). In such examples, the expected latency to be satisfied over the Uu link for the PDU will be lower than a default PDB typically used for sending such PDUs. In other examples, a PDU may arrive early or the importance value of a PDU may be determined low (e.g., below a threshold). In such examples, the expected latency over the Uu link may be considered to be more relaxed than a PDB typically used for sending such PDUs. As described, expected QoS of PDUs and/or PDU sets may vary dynamically based on the QoS experienced during reception from application and/or higher layers and/or based on importance/priority indications. Thus, for a fixed QoS (e.g., PBR, PDB), an increase or decrease in expected QoS prior to reception may translate to decrease or increase in expected QoS over a Uu link.

Example techniques for supporting adaptive scheduling of one or more PDUs and/or PDU sets are provided. In some examples, a WTRU may support adaptive scheduling when handling data transmissions associated with PDU sets, at one or more levels of QoS granularity (at, e.g., flow level, PDU set level, or PDU level). In various examples, a WTRU may support adaptive scheduling and/or assist a network supporting adaptive scheduling of PDU sets during data transmissions based on one or more of the following: configurations, triggering events, conditions and/or criteria received from network, and conditions and/or criteria received from application. In examples, a WTRU may be configured with one or more conditions and/or configurations associated to the handling of PDUs associated with PDU sets to be transmitted to a network or received from a network. Such conditions and/or configurations may be related to or may reflect an expected QoS to the achieved for PDUs and/or PDU sets during transmission to the network (in UL) or reception at WTRU (in DL) or a change of such expected QoS.

In examples, a WTRU may be configured to use PDU set traffic information from an application layer to determine an adaptive scheduling approach (e.g., DG-based, CG-based, CG+DG-based, etc.) for performing UL transmissions in accordance with associated QoS requirements. In some example techniques, a WTRU may assist a network (e.g., base station) by providing information about XR traffic patterns and requirements (e.g., importance of PDUs or PDU set delay budget) to support a better utilization of radio resources, save energy, and meet XR QoS requirements. In some example techniques, a WTRU may perform some actions (e.g., to enhance reliability of XR data transmission) by triggering changes for LCH-associated SR resources or CG configs based on some triggering conditions (e.g., urgency of data, deadline, failure in previous transmissions, etc.).

In examples, a WTRU may send information associated with supporting application awareness and/or QoS handling (e.g., association of PDUs to PDU sets) to a network. Such information may enable the network to have awareness of application and/or traffic parameters supported by WTRU. Information associated with application-awareness and/or QoS may be sent by a WTRU to a network as, for example, assistance information, preferred configuration information (e.g., preferred mapping and/or forwarding configurations to apply in UL/DL), status information (e.g., associated with AS layers), measurement and/or status reports (e.g., WTRU pose information, channel and/or link measurements, buffer occupancy measurements, etc.), request and/or response messages, etc.

In examples, such information may be sent by WTRU periodically (e.g., using one or more configured periodicity values), dynamically (e.g., when detecting triggering events and/or conditions described herein), as an update message (e.g., when detecting a change in information sent previously), or on a semi-persistent basis (e.g., sent with a periodicity value over a time span). In an example, a WTRU may switch between a first periodicity value and a second periodicity value for sending information, possibly based on the type of event detected (e.g., change in PDU set characteristics). In examples, a WTRU may change between sending information periodically to dynamically based on whether a change and/or amount of change detected in information sent.

In examples, a WTRU may send such information to a network via any of the following: RRC signaling and/or messages, control PDUs associated with an AS layer (e.g., SDAP control PDU, PDCP control PDU, etc.), UL MAC CE (e.g., buffer status report (BSR), pre-emptive BSR, elastic BSR, etc.), uplink control channel (UCI) (e.g., scheduling request (SR), ARQ/HARQ feedback, ACK/NACK, CSI), physical uplink control channel (PUCCH), physical uplink shared channel (PUSCH) (e.g., containing piggybacked UCI or a first/second phase UCI), reference signals (e.g., DMRS, CSI-RS, SRS, SRS for positioning), Non-AS (NAS) layer signaling (e.g., PDU session related messages), and application layer signaling.

In examples, such information sent to a network may include identifiers (IDs). For example, a WTRU may send any of: IDs associated with application (e.g., application ID, service ID, session ID, application configuration ID, etc.); group ID (e.g., associated with group of QoS flows, group of forwarding configurations, group of WTRUs, etc.); IDs of one or more QoS flows, mapping configurations, forwarding configurations; data type and/or message ID (e.g., PDU set ID, PDU ID, IDs associated with pose information, FoV information, media/video frame information, etc.); association ID (e.g., ID or sequence number indicating association between one or more UL PDUs and/or PDU sets and one or more DL PDUs, PDU sets and/or PDU flows).

In examples, such information sent to a network may include indication of priority of applications supported by a WTRU. For example, a WTRU may send IDs of the applications supported and/or information on the relative/absolute priority values associated with supported applications.

In examples, such information sent to a network may include data flows associated with an application. For example, a WTRU may send IDs associated with a QoS flows supported per application. Likewise, a WTRU may send priority values associated with QoS flows of different applications supported.

In examples, such information sent to a network may include devices associated with an application. For example, a WTRU may send IDs associated with devices supported and/or the association of the devices per application.

In examples, such information sent to a network may include data and/or traffic types associated with data flows per application. For example, a WTRU may send information about QoS flows associated with an application, where the data type may include video data (e.g., I-frame data, P-frame data, B-frame data), RGB-D data, 360 degrees video data, haptics data, pose and/or positioning data, audio data, etc.

In examples, such information sent to a network may include traffic characteristics and/or parameters of traffic associated with QoS flows per application. For example, a WTRU may send information on traffic characteristics of QoS flows associated with an application, including whether such data is periodic, aperiodic, semi-persistent, quasi-periodic, etc. Such traffic characteristics may include the one or more periodicity values of the flow. For example, a WTRU may send information related to the number of PDUs expected per PDU set in one or more flows per application. Such information of number of PDUs per PDU set may also include statistical information such as mean, minimum, maximum, or standard deviation values. Likewise, in some examples a WTRU may send information related to a PDU set, which may include size of the PDU set (e.g., total payload, number of PDUs in PDU set, etc.), indication of first and/or last PDU of PDU set, and indication of the association/dependency of PDUs in the PDU set (e.g., ID of PDU set, importance value, priority value, etc.). For example, a WTRU may send information related to jitter in UL and/or in DL. Such jitter information may be sent on a per-flow, per-PDU, or per-PDU set basis, and may include, e.g., descriptive statistics such as range, mean, maximum value, and minimum value. For example, a WTRU may send indications when detecting changes to the UL and/or DL traffic patterns (e.g., changes to periodicity, changes to mean payload sizes, changes to jitter range, etc.). For example, a WTRU may send information representing a prediction of traffic pattern in UL and/or DL for upcoming data (e.g., timing, size, importance of data to be received, uncertainty and/or confidence level of prediction, etc.). For example, a WTRU may send information indicating whether one or more PDU and/or PDU sets transmitted in UL may be followed by ACK/NACK feedback indications, which the WTRU may expect to receive from the application layers (e.g., TCP, RTP) and/or lower layers (e.g., ARQ, HARQ) with or without an associated a time window following UL transmission. In a like example, a WTRU may send information indicating whether one or more PDU and/or PDU sets received in DL may be followed by ACK/NACK feedback indications, which the WTRU may expect to transmit to the application layers (e.g., TCP, RTP) and/or lower layers (e.g., ARQ, HARQ) with or without an associated a time window following DL reception. For example, a WTRU may send information related to expected one or more PDU sets (e.g., size of a PDU set, descriptive statistics about a PDU set such as mean, maximum payload size, minimum payload size, a count of PDUs in a set, sizes of one or more PDUs in a PDU set, importance of PDUs in a set, etc.). For example, a WTRU may send information indicating PDU set QoS requirements (e.g., PDU set latency bound, reliability configuration requirements, etc.) For example, a WTRU may send intermediate QoS status information (e.g., a report of ACKs/NACKs of previous PDUs to indicate change in importance, urgency, or reliability of transmission for the incoming PDUs).

In examples, such information sent to a network may include buffer information at networking layers such as application layer, AS layer, and a higher layer, among others. For example, a WTRU may send information indicating an amount of data payload or a buffer level (e.g., with respect to one or more configured threshold values) at an application. Such payload and/or buffer information may include indication of data waiting to be delivered to lower layers for UL transmission or data received in DL which may be waiting to be consumed, depleted, or otherwise processed. Such buffer information may be reported as, for example, an estimated or a measured time duration for data held in a buffer before delivery to lower layers or consumption by an application. Such buffer information may be reported, for example, in terms of rate of data delivered to lower layers or rate of data consumption and/or depletion at higher layers (e.g., determined as ratio of payload size and time duration). For example, a WTRU may send information corresponding to an amount of data payload or a buffer level (e.g., with respect to one or more configured threshold values) at higher layers (e.g., NAS layer) and/or AS layers (e.g., in SDAP, PDCP, RLC, MAC, LCHs, LCGs).

In examples, such information sent to a network may include QoS parameters or expected QoS associated with data. For example, a WTRU may send QoS parameters or expected QoS of the one or more flows associated with an application (including, e.g., data rate, latency, reliability, absolute and/or relative priority values, etc.). Such QoS information may include descriptive statistics such as mean, minimum value, maximum value, standard deviation, etc., in various examples. For example, a WTRU may send indication that such QoS requirements or expected QoS may be supported on different QoS granularities (such as per PDU, per PDU subgroup within PDU set, per PDU set, per group of PDU sets, per flow, per session, etc.). A WTRU may send indication, in further examples, of a time window (e.g., defined by start time and duration, start time and end time, or other) during which such QoS requirements or expected QoS may be applicable to the different QoS granularities.

In examples, such information sent to a network may include information received from application and/or higher layers. For example, a WTRU may send statistical information about a PDU set (e.g., average PDU set size and average number of PDUs per PDU set). For example, a WTRU may send information per-PDU set (e.g., PDU set payload size, PDU set delay budget, etc.) and/or per-subset of one or more PDUs within a PDU set (e.g., PDU size, PDU importance, expected arrival times, etc.). For example, a WTRU may send indication of detection of a change in QoS expectation (e.g., reliability requirements or delay budget) due to an emerging change in XR traffic.

In examples, such information sent to a network may include resource configuration information. For example, a WTRU may send information on preferred resource configurations (e.g., number of slots for a CG cycle, period, or occasion; preference for one or more CG configurations among a set of candidate CG configurations, start offset time slot for a CG cycle/configuration, etc.). For example, a WTRU may send a flag indicating whether a CG update request is a one-time change (e.g., for a single CG occasion, period, or cycle) or semi-persistent change (e.g., for a number of CG occasions/periods). Indication that a CG update is a semi-persistent change may, in examples, imply that following consecutive PDU sets may have similar characteristics until further indication is triggered/sent.

In examples, such information sent to a network may include round-trip time (RTT) latency information. For example, RTT latency information provided a WTRU may include end-to-end-to-end latency (e.g., application on WTRU to application on server to application on WTRU). Such RTT latency may include, in various examples, motion-to-photon (e.g., delay between the movement of the user and the change of the device's display reflecting the user's movement), motion-to-audio, and motion-to haptics. Such RTT information may be provided, in various examples, by a WTRU at different granularities including on a per-PDU basis, a per-PDU set basis, a per flow basis, or a per-session basis. For example, RTT latency information provided a WTRU may include latency components associated with over-the-air UL transmission and DL reception (e.g., over Uu link) and/or latency in the network (e.g., upstream and downstream). Such RTT latency may or may not include, in various examples, the latency at the application layer (e.g., processing, rendering, encoding and/or decoding latency, etc.).

In examples, such information sent to a network may include flow synchronization information. For example, a WTRU may send information describing synchronization, including delay difference between one more PDUs and/or PDU sets in one or more correlated flows of the same and/or different devices/users (e.g., visual-tactile synchronization delay, audio-tactile synchronization delay, etc.). Such synchronization delay difference may correspond to a delay between arrival of a PDU of a PDU set in a first flow and arrival of a last PDU of a PDU set in an associated second flow, for example. For example, a WTRU may send information on synchronization, including delay difference between unicast and multicast flows (e.g., for one-to-many and many-to-many interactions).

In examples, such information sent to a network may include pose information (e.g., orientation, position, location, etc.). For example, pose information provided a WTRU may include one or many measurements in spatial dimensions such as longitude, latitude, altitude, roll, pitch, yaw, etc. in one or more coordinate systems (e.g., cartesian, spherical). For example, pose information provided a WTRU may indicate an orientation and/or location of the WTRU. The WTRU may, in examples, include information corresponding to movement of the WTRU (e.g., rate of movement in terms of linear movement and/or rotational movement).

In examples, such information sent to a network may include capability information associated with connectivity. For example, information on interfaces may include a number and/or types of interfaces (e.g., NR Uu, NR SL, WiLAN, Bluetooth), supported by a WTRU. For example, capability information on interfaces possibly supported by a WTRU and/or required by the WTRU for supporting the WTRU's actions, may include any of the following: bandwidth, BWP, number of carriers, number of transmit antennas, number of receive antennas, etc.

In examples, such information sent to a network may include capability information associated with WTRU actions. For example, capability information related to WTRU actions, including visual sensing, possibly supported by the WTRU (e.g., sensors, camera associated with UE) and/or required by WTRU may include any of the following: FoV resolution (e. g, megapixel count), rendered viewports (e.g., viewport ID), FoV size (e.g., 120 degrees), aperture size, shutter lag and startup time, image quality (e.g., min/max range), zoom lens options, image stabilization, exposure settings, battery life, sound/audio, display calibration (e.g., corrections applied for distortion and chromatic aberration), and capability to merge overlapping frames from different angles (e.g., stitching frames from individual captures together for panoramic image/video).

In examples, such information sent to a network may include preferred configuration information. For example, a WTRU may send to a network one or more preferred mapping configurations, forwarding configurations, and/or resource configurations (e.g., CG, DG), in some examples including specific parameters associated with the forwarding and/or resource configurations, for supporting the WTRU's actions, including those that may be performed by the WTRU and/or an associated device.

Further illustrating forwarding configuration examples, such forwarding configurations sent by a WTRU associated with the supported and/or requested UP/CP configurations (e.g., radio bearers, LCHs, links) may include one or more of latency requirements (for a PDU, e.g., latency requirements may be expressed in terms of packet delay budget associated with IP packets; for a PDU set, e.g., latency requirements may be expressed in terms of PDU set delay bound or Frame Delay Budget associated with the PDU set such for media frames), data rate requirements (for a PDU, e.g., data rate may be expressed in terms of bit rates associated with one or more PDUs; likewise for a PDU set, e.g., data rate may expressed in terms of bit rates associated with one or more PDU sets), reliability requirements (for a PDU, e.g., reliability may be expressed as packet rate error; for a PDU set, e.g., reliability may be expressed as frame error rate or PDU set error rate), importance values (e.g., absolute and/or relative importance and/or priority values associated with UP/CP configurations including radio bearers, logical channels, links, etc.), and LCP configurations. A WTRU may indicate, in various examples, what LCP rules and/or restrictions (e.g., restrictions associated with mapping from DRB/LCHs to configured resource grants) that may be applied for a set of forwarding and/or resource configurations (e.g., CG), whether such LCP rules/restrictions may be temporarily changed for a time duration, what conditional LCP configurations apply when detecting certain configured events (e.g., surge in number of PDUs/data with high QoS requirements), and what default LCP configurations prevail.

Further illustrating forwarding configuration examples, a WTRU may associate and/or indicate weight values (e.g., probability values) to different forwarding configurations when sending a request related to a preferred configuration. In such examples, the weight value may be determined based on the likelihood of a configuration to be applied during transmission and other application or AS layer information. A network may use such weight values to determine and provide to the WTRU a combined configuration and/or to activate or to deactivate a configuration that may match with the weight values indicated by the WTRU.

Returning to example techniques for supporting adaptive scheduling of one or more PDUs and/or PDU sets, a WTRU may send information to a network such as indication for activating and/or deactivating configurations. For example, a WTRU may send an indication to a network to request activating and/or deactivating a mapping, forwarding, or resource configuration and/or parameters associated with the configurations. In examples, such configurations and/or parameters may be preconfigured in the WTRU. Such indications may, in examples, include an ID of a configuration and/or parameter when sending a request indication. In examples, a request to activate and/or deactivate a configuration may be accompanied with information corresponding to a WTRU action (e.g., splitting or merging one or more PDUs, QoS flows, or PDU sets).

In examples, such information sent to a network may include measurements related to an application or AS layer. For example, a WTRU may send one or more of reference signal received power, reference signal received quality, and received signal strength indication measurements of signals, channels, radio links, carriers, etc., possibly associated with one or more WTRU actions. For example, a WTRU may send pose and/or positioning measurements (e.g., location information, pose in 6DoF, rate of WTRU motion). For example, a WTRU may send measurements and/or estimations related to RTT/MTP, application buffer level, buffer depletion time, depletion rate, etc. For example, a WTRU may send QoS related measurements including one or more of those related to number of PDUs and/or PDU sets received over a time duration, change in the QoS (e.g., increase/decrease in data rate, latency, reliability, etc.), time-to-live associated with the PDUs and/or PDU sets, and remaining time for delivering the PDUs and/or PDU sets.

In examples, such information sent to a network may include uncertainty information. For example, for other information sent by a WTRU including application layer information (e.g., pose info, QoS flows, MTP latency, etc.) or AS-layer information (e.g., preferred forwarding configurations, RTT latency, etc.), the WTRU may also send an uncertainty associated with the information. To illustrate, in examples where a WTRU may perform prediction or estimation of a parameter (e.g., RTT latency), the WTRU may indicate to network an uncertainty associated with the estimation.

In examples, a WTRU may receive information applicable to supporting adaptive scheduling. Such supporting information may be used by a WTRU to enable various techniques, mechanisms, rules, actions etc., associated with adaptive scheduling during UL transmissions and/or DL receptions of one or more PDUs and/or PDU sets in one or more data flows. Such supporting information may be received by a WTRU from a network periodically (e.g., with one or more configured periodicity values), dynamically (as, e.g., status indication, request messages, etc.) and/or on semi-persistent basis (e.g., sent with a periodicity value over a time duration). The WTRU may receive the configuration/assistance information/indications via, e.g., RRC signaling and/or messages (e.g., dedicated/unicast signaling, broadcast, etc.), control PDUs associated with one or more AS layers (e.g., SDAP control PDU, PDCP control PDU, etc.), DL MAC CE, DCI, PDCCH, PDSCH (e.g., containing piggybacked DCI or a first/second phase DCI), wake-up signal (WUS), reference signals (e.g., DMRS, PRS, CSI-RS), ARQ/HARQ feedback (e.g., ACK/NACK feedback), etc. Examples of such supporting information are provided.

In examples, adaptive scheduling supporting information may include one or more mapping, forwarding, and resource configurations and/or parameters. For example, a WTRU may receive one or more configurations and/or sets of configuration parameters to be applied at different layers an AS protocol stack (e.g., RRC, SDAP, PDCP, RLC, MAC, PHY, etc.). Example such configuration parameters for various AS layers are provided.

For a SDAP/PDCP AS layer, such parameters may include 1-to-1, 1-to-M or N-to-M mapping configurations; markings, indications, and/or IDs to apply (e.g., associated with handling QoS flows, PDU sets, association information between UL and DL PDUs/PDU sets); a range of values associated with importance and/or priority information to identify in one or more PDUs and/or PDU sets. A SDAP/PDCP mapping configuration may refer to information associated with mapping a packet at an SDAP layer to a PDCP entity and/or sublayer. For a PDCP AS layer, such parameters may include IDs and sequence numbers to apply, RoCH configuration, security/encryption parameters, packet duplication configuration

For a RLC AS layer, such parameters may include parameters associated with AM, UM, and/or TM operation.

For a MAC AS layer, such parameters may include LCH parameters (e.g., priority, PBR, BSD for PDU and/or PDU set level), LCP configurations (e.g., rules, restrictions, and/or policy for PDU and/or PDU set level handling, time duration for changing between different LCP rules and/or policy), LCP restrictions (e.g., association and/or restriction between LCHs and SR resources, association and/or restriction between CG configurations and/or resources), a set of possible SR resources and/or configurations and associated LCHs that may apply when relaxation of some LCP restrictions is activated and/or deactivated, and/or configurations for multiplexing or assembling of one or more PDUs/PDU sets.

For a PHY AS layer, such parameters may include MCS and/or HARQ configurations.

In examples, adaptive scheduling supporting information may include resource configurations. Example such resource configurations are provided.

In examples, resource configurations may include configured grant (CG) configurations for UL data transmissions. Parameters associated with CG configurations may include one or more values indicating periodicity, start offset, duration, BWPs, numerology/SCS, a number of PRBs per slot, a number of occasions, a number of PUSCH slots per occasion, a maximum size of PUSCH, one or more MSC values for a grant, antenna ports, etc.

In examples, resource configurations may include CG configuration update actions that may be allowed for a WTRU (e.g., permissible changes in CG configs may include increasing, decreasing, and/or or skipping one or more slots such as PUSCH slots, adding new/extra or cancelling one or more CG occasions, shifting some occasions in time (e.g., such as by advancing or delaying the occasions by a number of occasions), shifting some occasions in frequency (e.g., such as PRBs) modifying some parameters in one or more CG occasions corresponding to the number of PRBs, MCS values, number of symbols, transmission configuration indications (TCI), quasi-colocation (QCL), etc.).

In examples, resource configurations may include CG configuration update action options allowed for a WTRU (e.g., totally flexible or limited changes for increasing and/or decreasing a number of PUSCH slots per CG occasion).

In examples, resource configurations may include semi-persistent scheduling (SPS) configurations for DL data receptions. Parameters associated with SPS configurations may include one or more periodicity, start offset, duration, BWPs, numerology/SCS values, number of PRBs per slot, number of occasions, number of PDSCH slots per occasion, maximum size of PDSCH, one or more MCS values for a grant, antenna ports, etc.

In examples, resource configurations may include SPS configuration update actions that may be allowed for a WTRU (e.g., permissible changes in SPS configurations may include increasing, decreasing, and/or or skipping one or more slots such as PDSCH slots, adding or cancelling one or more SPS occasions, shifting some occasions in time (e.g., such as by advancing or delaying the occasions by a number of occasions), shifting some occasions in frequency (e.g., such by as PRBs), modifying some parameters in one or more SPS occasions corresponding to a number of PRBs, MCS values, number of symbols, TCI, QCL, etc.).

In examples, resource configurations may include dynamic grant (DG) resources for UL data transmission (e.g., triggered by UCI, SR, BSR, MAC CE). Parameters associated with DG one or more values indicating start offset, duration, BWPs, numerology/SCS values, number of PRBs per slot, number of PUSCH slots per occasion, maximum size of PUSCH, one or more MSC values for a grant, antenna ports, etc.

In examples, resource configurations may include dynamic scheduling/grant (DS/DG) resources for DL data receptions (e.g., triggered by DCI, PDCCH, MAC CE). Parameters associated with DS/DG one or more values indicating start offset, duration, BWPs, numerology/SCS values, number of PRBs per slot, number of PDSCH slots per occasion, maximum size of PDSCH, one or more MSC values for a grant, antenna ports, etc.

In examples, resource configurations may include timing info/windows indicating when at least some of the CG, SPS or DG configurations/parameters may be updated for a WTRU.

In examples, adaptive scheduling supporting information may include at least one set of configuration parameters associated with default configuration, which may be activated and/or used during normal scenarios for transmitting and/or receiving data. A WTRU may receive one or more additional sets of configuration parameters which may be associated with exceptional operation (e.g., which may be activated and/or used when detecting a triggering event and/or condition).

In examples, adaptive scheduling supporting information may include default priority values associated with resource configurations (e.g., CG). For example, a first resource configuration may be associated with a first priority value and a second resource configuration may be associated with a second priority value. Such first and second resource configurations may be associated with the same application and a first set of priority values may be associated with achieving a default QoS performance (e.g., default latency, default data rate, etc.) and a second set of priority values may be intended to achieve exceptional QoS performance (e.g., burst data rate, very low latency, etc.) for one or more PDUs and/or PDU sets using the first and second resource configurations during transmission.

For examples in which a WTRU may be configured with multiple PUSCH slots per CG occasion, multiple PDSCH slots per SPS occasion, multiple PUSCH slots per DG resource and/or multiple PDSCH slots per DG/DS resource, adaptive scheduling supporting information associated with one or more slots for various resource grants may be indicated or modified with a single DCI. A single DCI may include one or more DCI transmissions (e.g., in PUCCH or PDCCH) over one or more occasions. In examples, a WTRU may be configured with multiple PUSCH slots in a CG occasion. The multiple PUSCH slots may be used for transmitting multiple TBs per occasion. The multiple PUSCH slots may be configured in a WTRU by configuring and/or activating a single active CG configuration with multiple slots per occasion or multiple active CG configurations with single slot per occasion (e.g., with different start offsets for the slots).

For examples in which a WTRU may be configured with multiple PUSCH slots per occasion for one or more CG configurations, the WTRU may be indicated with a single DCI for indicating activation and/or deactivation, parameters and/or changes to CG configuration parameters (e.g., increases or decreases to a number of slots per occasion, time shifting by advancing or delaying some slots in one or more occasions, modifying parameters such as MCS and PRBs in one or more slots per occasion, etc.). Such single DCI may indicate changes to a single occasion or multiple occasions associated with CG configurations. In examples, a WTRU may be configured with multiple PDSCH slots in an SPS occasion. The multiple PDSCH slots may be used for receiving (in DL) multiple TBs per occasion. The multiple PDSCH slots may be configured in the WTRU by configuring and/or activating a single active SPS configuration with multiple slots per occasion or multiple active SPS configurations with single slots per occasion (e.g., with different start offsets for the slots).

For examples in which a WTRU may be configured with multiple PDSCH slots per occasion for one or more SPS configurations, the WTRU may be indicated with a single DCI for indicating activation and/or deactivation, parameters and/or changes to SPS configuration parameters (e.g., increases or decreases to a number of slots per occasion, time shifting by advancing or delaying some slots in one or more occasions, modifying parameters such as MCS and PRBs in one or more slots per occasion, etc.). Such single DCI may be used for indicating changes to a single occasion or multiple occasions associated with the SPS configurations. In examples, a WTRU may be configured with multiple PUSCH slots in per DG resource. Such multiple PUSCH slots may be used for transmitting multiple TBs per DG resource. The multiple PUSCH slots may be configured in a WTRU by allocating a single DG resource with multiple slots per DG resource or multiple DG resources with single slot per DG resource (e.g., with different start offsets for the slots).

For examples in which a WTRU may be configured with multiple PUSCH slots per DG resource, the WTRU may be indicated with a single DCI for indicating the parameters and/or changes to the DG parameters (e.g., increases or decreases to a number of slots per occasion, time shifting by advancing or delaying some slots in one or more occasions, modifying parameters such as MCS and PRBs in one or more slots per occasion, etc.). In examples, a WTRU may be configured with multiple PDSCH slots per DG/DS resource. The multiple PDSCH slots may be used for transmitting and/or receiving multiple TBs per DG/DS resource. The multiple PDSCH slots may be configured in a WTRU by allocating a single DG/DS resource with multiple slots per DG/DS resource or multiple DG/DS resources with single slot per DG/DS resource (e.g., with different start offsets for the slots).

For examples in which a WTRU may be configured with multiple PDSCH slots per DG/DS resource, the WTRU may be indicated with a single DCI for indicating parameters and/or changes to DG/DS parameters (e.g., increases or decreases to a number of slots per occasion, time shifting by advancing or delaying some slots in one or more occasions, modifying parameters such as MCS and PRBs in one or more slots per occasion, etc.).

In examples, adaptive scheduling supporting information may include identifiers (IDs). For example, a WTRU may receive information including one or more IDs to apply during transmission and/or reception. Example such IDs are provided. In examples, IDs may include WTRU IDs, such as C-RNTI, I-RNTI, NAS IDs, TMSI/IMSI, etc. In examples, IDs may include IDs associated with an application (such as one or more of an application ID, a service ID, a session ID, an application configuration ID, etc.). In examples, IDs may include group IDs (e.g., an ID associated with a group of QoS flows, a group of forwarding configurations, a group of devices and/or WTRUs, etc.). In examples, IDs may include IDs of individual QoS flows, mapping configurations, forwarding configurations, etc. In examples, IDs may include data type or message IDs (e.g., PDU set ID, PDU ID, etc.). In examples, IDs may include resource config IDs (e.g., CG IDs, SPS IDs, etc.).

In examples, adaptive scheduling supporting information may include a status of forwarding and/or resource configurations. For example, a WTRU may receive information on QoS achieved and/or achievable (e.g., latency, error rate, etc.) when using one or more such configurations. In examples, such information may be received by a WTRU in terms of a data-rate, latency (e.g., expected or remaining latency, etc.), reliability (e.g., error rate), and/or priority achievable and/or achieved when transmitting and/or receiving one or more PDUs or PDU sets. Likewise, a WTRU may receive statistical information associated with QoS achieved and/or achievable in terms of descriptive statistics such as mean value, maximum value, minimum value, standard deviation, etc.

In examples, adaptive scheduling supporting information may include flow control indications. For example, a WTRU may receive from a network explicit or implicit flow control indications associated with, e.g., starting, increasing, decreasing, suspending, or stopping transmission of one or more PDUs or PDU sets. Such flow control indications may be associated with achieving an indicated rate of transmission, latency, or error rate in one or more forwarding configurations.

In examples, adaptive scheduling supporting information may include validity information. For example, a WTRU may receive validity information associated with forwarding and/or resource configurations indicating whether or when such configurations may be considered valid or invalid based on one or more triggering conditions. A WTRU may further receive validity information indicating whether such configurations are to be deactivated and/or released when determined invalid. In examples, a WTRU may receive information indicating that configurations are to be considered valid based on an RRC state of the WTRU (e.g., CONNECTED, INACTIVE, IDLE, etc.) and/or when transitioning between different RRC states.

In examples, adaptive scheduling supporting information may include threshold values. Example such threshold values are provided.

In examples, threshold values may include one or more buffer occupancy threshold values. For example, buffer occupancy threshold values associated with forwarding configurations may indicate a maximum and/or minimum amount of data, PDUs, or PDU sets (e.g., in terms of total payload volume) that may be included in a buffer (e.g., application layer buffer, AS-layer LCH buffer, etc.) po In examples, threshold values may include one or more payload size threshold values. For example, payload size threshold values may be associated with one or more upper and/or lower bound values corresponding to the total size of a payload (e.g., in the units of bits or bytes) of one or more PDUs or PDU sets. In examples, payload size threshold values may be associated with one or more upper and/or lower bound values corresponding to the total number of PDUs in a PDU set.

In examples, threshold values may include one or more remaining latency threshold values when handling PDU sets. For example, a WTRU may receive one or more threshold values (e.g., maximum and/or minimum) associated with remaining latency for performing one or more actions during transmission and/or reception. Remaining latency may be related to transmitting remaining PDUs in a PDU set, for example. Likewise, remaining latency may refer to a difference between overall latency for transmitting PDUs in a PDU set (e.g., PSDB) and latency incurred for transmitting a subset of one or more PDUs in a PDU set, for example. WTRU actions that may be performed based on comparison of remaining latency for transmitting PDU sets with respect to remaining latency threshold values may include, for example, determining whether to trigger a request for new resources (e.g., triggering SR, BSR, etc.), determining changes to resource configurations (e.g., CG, DG, CG+DG, etc.), determining whether to relax LCP restrictions for accessing and/or switching to resources from other LCHs (e.g., CG resources, SR resources from other restricted LCHs, etc.), etc.

In examples, adaptive scheduling supporting information may include expected threshold time (ETT) values. Example such expected threshold time values are provided. For example, a WTRU may receive one of more ETT values or expected time of arrival (ETA) threshold values corresponding to an expected time for receiving one or more PDUs and/or PDU sets in a data flow, where a PDU may be the first or last PDU associated with a PDU set or a subsequent PDU after receiving earlier PDUs. In examples, ETT threshold values may be associated with the expected latency for a second PDU and/or PDU set after receiving and/or transmitting the first PDUs and/or PDU sets with a first latency value. In an example, the second PDU may correspond to the last PDU of a PDU set. In examples, ETT threshold values may be associated with the expected latency for the PDUs/PDU set in a second associated data/QoS flow after receiving and/or transmitting the one or more PDUs and/or PDU sets in a first data flow with a first latency value. In examples, an ETT threshold value may be associated with a time duration or timer value. In examples, a WTRU may start a timer at a time instance when receiving and/or transmitting a first PDU and stop the timer when the timer expires at the time instance corresponding to the threshold time value and/or when receiving and/or transmitting a second PDU (e.g., first and second PDU may be associated with the same PDU set).

In examples, adaptive scheduling supporting information may include expected data rate (EDR) threshold values. Example such EDR values are provided. For example, a WTRU may receive one or more EDR threshold (EDR) values associated with the data rate expected for receiving and/or transmitting one or more PDUs and/or PDU sets in one or more data flows. A data rate may correspond to any of the following units: PDUs/PDU sets per second, frames per second, bits/bytes per second, etc. In examples, EDR threshold values may be associated with the EDR for a second PDU and/or PDU set after receiving and/or transmitting a first PDU and/or PDU set with a first data rate value. In examples, the EDR threshold values may be associated with the EDR for one or more PDUs and/or PDU sets in a second associated data flow after receiving and/or transmitting one or more PDUs and/or PDU sets in a first data flow with a first data rate value.

In examples, adaptive scheduling supporting information may include expected reliability (EER) threshold values. Example such EER values are provided. For example, a WTRU may receive one or more EER values associated with the reliability expected for receiving one or more PDUs and/or PDU sets in one or more data/QoS flow. The reliability values may correspond to any of the following units: packet error rate, frame and/or PDU set error rate, probability of error, etc. In examples, EER threshold values may be associated with an expected reliability for a second PDU and/or PDU set after receiving and/or transmitting a first PDU and/or PDU set with a first reliability value. In examples, EER threshold values may be associated with an expected reliability for one or more PDUs and/or PDU sets in a second associated data/QoS flow after receiving and/or transmitting one or more PDUs and/or PDU sets in a first data/QoS flow with a first reliability value.

In examples, threshold values may include one or more pose difference threshold values. For example, a pose difference threshold value may correspond to the difference between a measurement of pose information at a first time instance and a second time instance, where the time instances may correspond to any of the following units: time slots, symbol duration, SFN, seconds, milliseconds, etc.

In examples, threshold values may include one or more a WTRU movement threshold values. For example, a WTRU movement threshold may correspond to the difference between a location or rotation angle of a WTRU between a first time instance and a second time instance, where the time instances may correspond to any of the following units: time slots, symbol duration, SFN and seconds, milliseconds, etc.

In examples, threshold values may include one or more correlation time window values. For example, a correlation time window may correspond to the minimum time difference between two triggering events (e.g., pose information measurements, QoS events, etc.), where the two events may be considered correlated when they occur within the correlation time window. When the two events occur at time instances beyond the correlation time window, they may be considered independent. In examples, a WTRU may use a correlation time window for determining whether to send an indication to a network (e.g., indicating change a WTRU location/movement or change in QoS).

In examples, a WTRU may receive triggering events and/or conditions applicable to supporting adaptive scheduling. A WTRU may be configured with one or more triggering conditions related to triggering a WTRU action, such as sending assistance information and/or indications to a network, receiving configuration and/or assistance information from network, sending an indication and/or request for changing resource configurations, sending an indication and/or request for changing forwarding configurations, etc. Such triggering events/conditions may be related to adaptive scheduling and/or for meeting QoS requirements (e.g., latency, reliability) when transmitting/receiving PDUs/PDU sets in one or more associated QoS flows. Such triggering events/conditions may determine whether and which action may be performed by a WTRU. Such triggering events/conditions may determine when (at what time instant) an action may be performed by a WTRU. For example, a WTRU may select a resource configuration (e.g., CG, SPS, DG, etc.) for meeting an expected QoS based on detection of one or more triggering events and/or conditions. Examples of such triggering events and/or conditions are provided.

In examples, triggering events and/or conditions may include information from a network.

For example, a WTRU may receive from a network (e.g., gNB, etc.) an indication of expected and/or achievable QoS for transmission and/or reception over a Uu link (in UL and/or DL). Such indication may be received semi-statically, during configuration, or dynamically. A WTRU may trigger a WTRU action (e.g., determining/selecting a mapping, forwarding or resource configuration) based on the indication received from network. In such an example, expected and/or achievable QoS may be indicated per PDU, per PDU set, per QoS/data flow, per forwarding configuration, per-resource configuration, etc.

In other such examples, a WTRU may receive from a network (e.g., gNB, etc.) information associated with expected and/or achievable QoS implicitly based on one or more of the following: number of time HARQ feedback is received, size and/or timing for allocation of resource grants (configured grants, dynamic grants, etc.), allocation of retransmission grant corresponding to one or more forwarding configurations (e.g., LCHs, DRBs, BWPs, etc.), de-prioritization of PUSCH for one or more LCHs due to intra-or inter-WTRU prioritization, etc.

In other such examples, a WTRU receive an indication from a network (e.g., in RRC, MAC CE, other control PDU or DCI, etc.) and may be triggered to perform one or more WTRU actions. In examples, such indication received by a WTRU may be related to a change in forwarding and/or resource configuration at a WTRU and/or expected QoS associated with one or more PDU sets or QoS flows.

In examples, triggering events and/or conditions may include indication and/or information from application and/or higher layers. Examples of such indication and/or information from application and/or higher layers are provided.

For example, a WTRU may perform one or more WTRU actions when receiving an indication from application and/or higher layers. Such indication may include information on the change of traffic characteristics associated with generating, processing, receiving of one or more PDUs and/or PDU sets in one or more data flows.

In examples, an application may indicate to a WTRU information on an expected number of QoS flows which may be associated with the application, expected number of PDUs per PDU set, expected frame and/or PDU set in one or more subsequent time instances (e.g., a next frame generation instance), expected change in the distribution of priority of one or more PDUs generated, expected increase and/or decrease in latency (e.g., due to processing at application), expected increase and/or decrease in QoS (e.g., latency, error rate, etc.), jitter for delivering PDUs and/or PDU sets in UL and/or DL, expected change in the time-to-live associated with one or more PDUs and/or PDU sets, expected change in WTRU movement (e.g., increase and/or decrease in rate of motion), etc.

In examples, a WTRU may receive an indication from application and/or higher layers indicating an arrival of one or more PDUs and/or PDU sets (e.g., in a batch) from an application in a WTRU (for UL) or from application in a network (for DL). Such information on arrival of the one or more PDUs and/or PDU sets may include an expected timing (e.g., time slot, time frame, etc.) of generation at an application and/or an expected timing of reception at a WTRU. Such information may be indicated to a WTRU via timestamps, sequence numbers, or the like.

In examples, a WTRU may be triggered to perform one or more WTRU action based on an indication of priority for transmitting one or more PDUs and/or PDU sets. In examples, a WTRU may trigger an action (e.g., change forwarding and/or resource configuration) for sending delayed PDUs with compensation (e.g., low latency) when receiving an indication containing a priority value higher than a threshold.

In examples, triggering events and/or conditions may include buffer status and/or loading at forwarding configurations (e.g., DRBs/LCHs). Such buffer status may include at least one condition associated with one or more of the following: an amount of one or more PDUs and/or PDU sets in one or more buffers associated with forwarding configurations, possibly over a period of time; a rate of arrival and/or departure of one or more PDUs and/or PDU sets in one or more buffers associated with forwarding configurations; an average, maximum, minimum volume of one or more PDUs and/or PDU sets in a buffer associated with forwarding configurations (e.g., number of PDUs in LCH buffer); a measure of an amount of time spent by one or more PDUs and/or PDU sets in buffers associated with forwarding configurations; a number of forwarding configurations meeting a condition and/or threshold associated with an amount of data, arrival rate, PDU and/or PDU set size (e.g., total payload size); etc. Examples of such buffer status are provided.

In examples, a WTRU may perform one or more actions (e.g., change a forwarding configuration, change a resource configuration, etc.) if at least one PDU or PDU set in a forwarding configuration (e.g., UL LCH buffer waiting to be transmitted in UL, DL LCH buffer waiting to be processed, etc.) is in a buffer for a period of time exceeding a threshold time value.

In examples, a WTRU may perform one or more actions (e.g., send a report or a status indication) if a buffer status of a forwarding configuration exceeds a threshold. In examples, buffer status metrics that may be monitored to determine an expected QoS include a number of PDUs and/or PDU sets buffered in excess of a configured threshold in one or more associated forwarding configurations, or a rate of PDU or PDU set arrival and/or departure in a buffer with respect to a configured arrival/departure rate.

In examples, a WTRU may determine a number of PDUs and/or PDU sets received over a time duration for evaluating whether a rate of PDUs received (e.g., from higher layers for UL transmission or from a network for DL reception) is within a range expected for a QoS. In examples, such time duration may be used to evaluate whether one or more PDUs and/or PDU sets received from a network are received within a latency bound. A WTRU may then select a mapping configuration for adjusting the expected QoS if such PDUs and/or PDU sets are received outside of the range expected for QoS.

In examples, triggering events and/or conditions may be associated with a change in configuration at a WTRU. Examples of such change in configuration are provided.

In examples, a WTRU may be triggered to perform an action (e.g., sending an indication and/or report to a network) when determining a change to a mapping configuration, a forwarding configuration, and/or a resource configuration, including changing at least one of the parameters at the mapping configuration (e.g., mapping a QoS flow to a new forwarding configuration), DRB and/or LCHs (e.g., priority, PDB, PBR, etc.), LCP configuration or restriction, and/or resource configuration or parameters (e.g., CG, DG, SPS, etc.).

In examples, a WTRU may be triggered to perform an action when a CDRX or DRX configuration or associated parameters applied at a WTRU is changed, for such changes as may possibly impact a transmission and/or reception pattern and/or QoS (e.g., RTT, etc.) achievable during data transmission and/or reception.

In examples, a WTRU may be configured with one or more PDCCH monitoring behaviors, where different monitoring behaviors may include one or more of high effort monitoring (e.g., high periodicity) and low effort monitoring (e.g., low periodicity). In examples, a WTRU may change from high effort monitoring to low effort monitoring based on detection and/or indication of change in a traffic pattern from high load (e.g., high number of TBs/slots) to low load (e.g., low number of TBs/slots) or vice versa.

In examples, a WTRU may be configured with PDCCH monitoring between a dense search space set group (SSSG) and a sparse SSSG. Such a WTRU may change from monitoring dense SSSG to monitoring sparse SSSG based on detection and/or indication of a change in traffic pattern from high load (e.g., high number of TBs/slots) to low load (e.g., low number of TBs/slots), or vice versa.

In examples, triggering events and/or conditions may be associated with timing information, which may further be associated with an expected QoS. Such timing information may include one or more of the following: one or more timestamps, one or more sequence numbers, one or more markers, one or more PDUs, etc. Examples of such timing information are provided.

In examples, a WTRU may track timing information in one or more PDUs and/or PDU sets received in an earlier time window for determining latency or jitter. Such timing information may then be used for determining an expected QoS for upcoming PDUs or PDU sets in a later time window (e.g., the next time window).

In examples, timing information may be a restrictive deadline, latency bound, or survival time. Such a restriction may be defined on a per PDU, per PDU set, or per-QoS flow basis. Such timing information may be determined across one or more associated QoS flows, including correlated UL flows, correlated DL flows, and correlated UL+DL flows, for example. In examples, such timing information may also be determined on a count basis (e.g., PDU or PDU set count). A WTRU may trigger an action (e.g., determining mapping and/or forwarding configuration) when determining, based on timing information, whether an expected QoS may or may not be met. In examples, a WTRU may send information on an expected QoS, based on measurements associated with a time duration one or more PDUs and/or PDU sets spend in a forwarding configuration (e.g., elapsed time from reception of one or more PDUs and/or PDU sets from higher layers to transmission in UL, elapsed time from transmission of one or more PDUs and/or PDU sets in UL to reception in DL, elapsed time from reception of one or more PDUs and/or PDU sets in DL to forwarding to higher layers, etc.).

In examples, a WTRU may send timing information on a latency (e.g., overall latency, remaining latency, etc.) for one or more PDUs and/or PDU sets transmitted in UL and received in DL based on measurement at AS layer entities and/or sublayers (e.g., SDAP, PDCP, RLC, MAC, etc.). In examples, a PDCP entity used by a WTRU for UL transmission of a PDU set may start a timer (e.g., discard timer, RTT timer, etc.), possibly including a sequence number and/or sending the PDU set to a lower layer. Such a WTRU may measure RTT latency at such PDCP entity based on reception of an associated PDU set with a corresponding sequence number (e.g., DL sequence number may be added by gNB). In such scenario, if the timer expires before receiving the PDU set in DL, a WTRU may send an indication to gNB to discard the PDU set, to send the PDU set with lower priority, or to send the PDU set with higher priority.

In examples, a WTRU may be configured with one or more discard timer values (e.g., at a PDCP entity) associated with QoS parameters associated with PDU sets forwarded using an associated DRB. For example, one or more discard timer values may be associated with PDU set delay bound (PSDB) values. In an example where the WTRU is preconfigured with a set of one or more discard timer values and/or the WTRU selects a discard timer value from a preconfigured set (e.g., based on monitoring and/or detection of the PSDB value of a PDU set), the WTRU may send an indication to the network (e.g., in RRC signaling, MAC CE, or UCI, etc.) indicating the selected discard timer value. In examples, when a discard timer expires at the transmitting PDCP entity (e.g., at the WTRU) or when a status report is received from the receiving PDCP entity (e.g., a base station) indicating successful reception of PDUs associated with the PDU set, the transmitting PDCP entity may discard any of the transmitted and/or remaining un-transmitted PDUs of the PDU set. In examples, the PDU discarding mechanisms applied may be vary among types of PDU sets handled by the WTRU and/or the priority values of one or more PDUs within a PDU set. For examples where a first subset of the PDU set (e.g., high priority) may have different QoS requirements than a second subset of the PDU set (e.g., low priority), it may be possible not to discard some of the PDUs in the first subset of the PDU set (e.g., high priority) even when the discard timer associated with the PDU set expires. The PDUs associated with the second subset of the PDU set (e.g., low priority) may be discarded, for example, when the discard timer expires. In examples where the PDUs may have similar QoS requirements (e.g., similar priority level), the remaining PDUs may be discarded when the discard timer associated with the PDU set expires.

In examples, a WTRU may send information to a network periodically or based on an expiry of a configured timer.

In examples, a WTRU may be configured for using any of CG-, DG-, and/or CG+DG-based resource grants. A WTRU may be configured with a timer associated with transmission of one or more PDU sets, for example. In examples, a WTRU configured to use a first resource configuration (e.g., a first CG configuration) may switch to using a second resource configuration (e.g., second CG configuration or a DG configuration), upon the expiry of the configured timer.

In examples, a WTRU may be configured with an adaptable CG configuration (e.g., allowing adaptation to CG resources based on L2/L1 signaling (e.g., DCI), which may be used so long as a configured timer is running and valid. In examples, such a WTRU may switch from using an adaptable CG configuration to a default CG configuration after expiry of the configured timer.

In examples, a WTRU may set a timer when using certain SR resources from a restricted LCH during transmission of one or more PDUs and/or PDU sets. In examples, such a WTRU may use SR resources (e.g., after relaxation of some LCP restrictions) so long as the timer is running. Such WTRU may fall back to using the SR resources associated with default LCHs upon expiry of the timer.

In examples, triggering events and/or conditions may include measurements based on one or more Uu links. Examples involving such Uu link measurements are provided.

In examples, a WTRU may use Uu link measurements corresponding to RSRP, RSSI, CQI, and/or CSI for determining an expected QoS. Channel and/or load measurements made over a time duration may indicate whether one or more PDUs and/or PDU sets may achieve the expected QoS during transmission and/or reception, or else may exceeded a QoS budget. A WTRU may trigger an action (e.g., determining mapping configuration) based on such channel and/or load measurements.

In examples, a WTRU may determine Uu link conditions based on a number of ARQ/HARQ (ACK/NACK) feedback messages and/or ARQ/HARQ retransmissions made over one or more HARQ processes associated with forwarding configurations associated with sending one or more PDUs and/or PDU sets. An updated QoS expectation may be determined based on a mapping function between determined Uu link conditions in UL and/or DL and an expected QoS. In examples, a ReTx (or retransmission) count above a threshold may indicate poor Uu link conditions and therefore resulted in reduced updated QoS expectation. In examples, changes to resource configurations (e.g., number of PUSCH slots for CG and/or DG) may be determined based on a mapping function between determined Uu link conditions in UL and/or DL and resource configurations. In examples, a ReTx count or number of NACK feedback receptions exceeding a threshold may translate to an increase or decrease in a number of slots per CG occasion or DG allocation. In various examples, a WTRU may determine Uu link conditions based on CSI reports transmitted to and/or received from a network.

In examples, a WTRU may be triggered to perform one or more actions (e.g., send an indication to a network) when Uu link conditions (based on, e.g., RSRP, RSSI, RSRQ, CQI, CSI) change to exceed a configured threshold and/or remains in excess of a threshold for a time duration.

In examples, a WTRU may be triggered to perform one or more actions when one or more QoS related measurements (e. g, latency measured for one or more PDUs and/or PDU sets in one or more forwarding configurations) exceeds a certain threshold.

In examples, a WTRU may trigger an action, based on determining a time duration or a jitter, or change in a time duration or a jitter between reception of consecutive PDUs associated with an PDU set, and/or reception of one or more PDUs and/or PDU sets in one or more correlated flows in UL and/or DL. In examples, a WTRU may infer a change in a jitter between consecutive PDUs to determine whether the processing load at an application or higher layer is high or low. To determine a time duration or a jitter, a WTRU may set a timer when a first PDU arrives and reset the timer when a second PDU associated with a PDU set associated with the first PDU arrives.

In examples, triggering events and/or conditions may include compensation based on expected QoS. Examples involving such compensation are provided.

For example, a WTRU may be triggered to perform one or more actions base on determination of expected QoS for one or more PDUs and/or PDU sets, where an expected QoS may indicate such PDUs may be either delayed or may arrive early during UL transmission and/or DL reception. In examples, a WTRU may trigger an action such that delayed or early PDUs sets may be transmitted with a determined compensation amount by, for example, selecting suitable resource configurations (such as CG or DG resources). In examples, if a WTRU determines a PDU has been delayed, it may select a forwarding and/or resource configuration appropriate to satisfying a compensation amount, where such compensation amount may be determined by subtracting an expected latency from observed or actual latency. In examples, such actions may be triggered when detecting a change to an expected QoS for the PDUs/PDU exceeding a certain threshold.

In examples, triggering events and/or conditions may include one or more properties associated with a link and/or channel to which a forwarding configuration is associated. Examples involving such properties are provided.

For example, a WTRU may be configured with a property specific to a forwarding configuration, link, and/or channel such as a priority or one or more parameters enabling or disabling actions per forwarding configuration, link, or channel. In examples, a link configured with a high priority property may allow a WTRU to change a configuration (with respect to an initial or default configuration). Such WTRU may change parameters of a link associated with high priority as long as such change impacts only other lower priority forwarding configurations, for example.

In examples, triggering events and/or conditions may include detection of QoS events, wherein QoS events may include, for example, a surge in payload size or arrive of high-importance data. Examples involving such QoS events are provided.

For example, QoS events may include surge events associated with an increase in a number of PDUs and/or PDU sets or an increase in data volume (e.g., within a time window) indicated high importance. Example QoS events may include QoS deflation associated with a decrease in a number of PDUs and/or PDU sets or a decrease in payload volume (e.g., within a time window). In examples, a QoS event may be detected when a WTRU detects poor or degraded radio conditions. Such poor or degraded radio conditions may be determined based on measurements, increased retransmissions, increased NACKs of uplink packets, etc.

For example, a WTRU may be triggered to perform one or more actions when detecting one or more QoS events, in some examples based on an expected duration of QoS event persistence. In examples, such a WTRU may perform one or more other actions such as falling back to a default configuration. In examples, when a surge event (e.g., increase in total payload or number of PDU sets) is detected, a WTRU may trigger an action to change a resource configuration in UL and/or DL (e.g., CG and/or SPS updated for the duration of the surge) such that the surge event may be accommodated within a latency bound. In examples, on determination of a reduction in the surge event or an end of the surge event, such WTRU may fall back to using a default resource configuration in UL and/or DL (e.g., default CG and/or SPS).

In examples, a WTRU may determine a resource grant type (e.g., DG, CG, or CG+DG) to use for transmitting one or more PDU sets in UL within an associated PDU set-level latency bound based on information including one or more of PDU set characteristics (e.g., PDU set payload sizes), resource configuration information, and/or a payload size threshold. In examples, a WTRU may determine, for example based on a PDU set traffic information received from an application layer and/or a higher layer, whether to use a default CG configuration or to trigger a request for DG allocation. An example for determining a resource grant type to transmitting one or more PDU sets in UL may be provided.

A WTRU may receive configuration information from a network (e.g., gNB, etc.), including one or more default CG resource configurations (e.g., a default CG resource configuration may include one or more parameters such as a number of PUSCH slots per occasion, a periodicity value, and a number of occasions) and minimum and maximum threshold values for total PDU set payload size (e.g., per occasion) that may be transmitted using default CG resources.

Such WTRU may receive a first PDU subset including or more PDUs associated with a PDU set from an application and/or higher layer (in some examples also including a traffic pattern information associated with the PDU set). In examples, such first subset may include a PDU set information (e.g., in one or more PDU headers) associated with the PDU set (e.g., total PDU set payload size, total number of PDUs in PDU set, PDU set delay budget, etc.).

Such WTRU may determine a resource grant type (DG, CG, or CG+DG) for transmitting the PDU set based on, for example, the configuration information and the PDU set information.

In examples where the total PDU set payload size is less than the minimum PDU set payload size threshold for CG, such WTRU may trigger SR and/or BSR to request DG resources. For example, the WTRU may provide explicit or implicit information about the PDU set delay budget, in some examples requesting allocation of DG PUSCH slots before the PDU set delay deadline. In examples, such WTRU may save transmit power by transmitting the PDU set over a number of one or more DG PUSCH slots that may be less than the number of PUSCH slots in a single CG occasion by sending a request for a single-shot DG, for example.

Such WTRU may transmit PDUs associated with the PDU set using such DG resources, in some examples after receiving an indication (e.g., in DCI) from a network (e.g., gNB, etc.) indicating allocation of DG resources. In examples, such WTRU may transmit an indication to the network indicating that at least a subset of the CG resources are not used for transmitting the PDU set.

In examples where the total PDU set payload is size is at least the minimum PDU set payload size threshold for CG, such WTRU may determine an expected latency for sending the PDUs associated with the PDU set based on the configuration information and, in some examples, on the minimum and/or maximum payload size threshold values.

In examples where the total PDU set payload is size is no more than the maximum PDU set payload size threshold for CG, and where an expected latency is less than the PDU set delay budget, such WTRU may transmit PDUs associated with the PDU set using resources and/or occasions provided in a CG resource configuration.

In examples where the total PDU set payload is size is at least the maximum PDU set payload size threshold for CG, such WTRU determine a number of excess CG occasions and/or payload sizes of PDUs associated with the PDU set that may be sent over remaining CG occasions based on the PDU set delay budget and the configuration information. In examples, such WTRU may trigger SR and/or BSR to request DG resources for transmitting additional PDUs (e.g., PDUs that may not fit within CG resources). For example, such WTRU may send explicit or implicit indication of payload sizes and/or remaining latency associated with the additional PDUs. In examples, such WTRU may send an indication of a number of excess CG occasions to the network that may be skipped (e.g., if excess occasions remain beyond the expected latency for sending the PDUs associated with the PDU set). Such WTRU may monitor for a DCI to receive DG resource allocation. Such WTRU may transmit the PDUs associated with the PDU set using CG resources and DG resources.

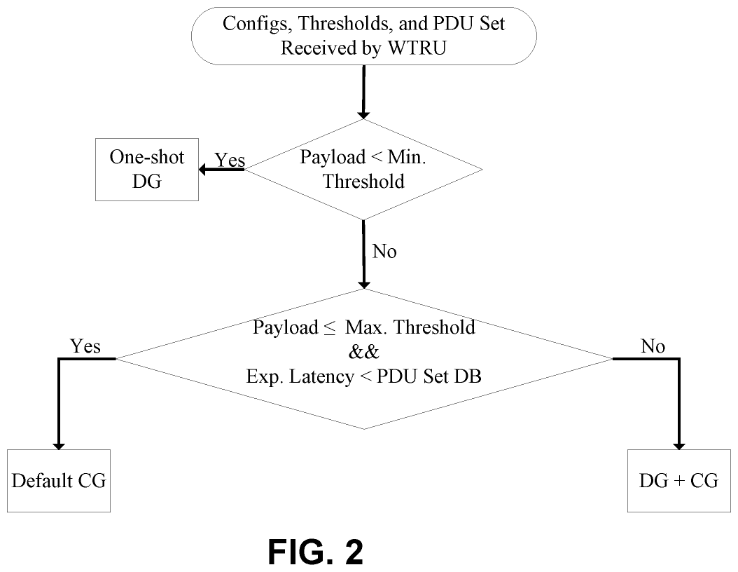

FIG. 2 illustrates how a WTRU may determine a resource grant type (e.g., DG, CG, or CG+DG) to use for transmitting one or more PDU sets in UL within the PDU set-level latency based on information including PDU set characteristics.

A WTRU may be configured to update the resource grant type to use for transmitting PDU sets in UL.

In examples, the WTRU may be configured with a resource grant type (e.g., DG, CG, or CG+DG) to use for transmitting one or more PDU sets in UL within the PDU-set level delay bound (PSDB) based on info on PDU set characteristics (e.g., PDU set payload sizes, PDU set delay budget), resource configuration info, and a configured payload size threshold. The WTRU may use the PDU set traffic information received from the application/higher layer to decide whether to use a default CG configuration, trigger a request for DG allocation, and/or use a different CG configuration. An example applied by the WTRU for determining the resource grant type to use during UL transmission of PDU sets may include the following.

The WTRU may receive configuration info from a gNB, including any of the following. The configuration info may include a default CG resource configuration (e.g., parameters of a default CG resource configuration may include a default number of PUSCH slots per occasion, a default periodicity value, and a default number of occasions). The configuration info may include a (e.g., second) CG configuration with a higher number of PUSCH occasions per slot than the default CG. The configuration info may include a (e.g., third) CG configuration with a lower number of PUSCH slots per occasion than the default CG.

The WTRU may receive a first subset consisting of one or more PDUs of a PDU set from the application/higher layer with traffic pattern info of the PDUs/PDU sets. The WTRU may determine the expected latency for sending the PDUs in the PDU set based on the configuration information received from the gNB on the CG resource configuration and a PDU set payload size.

The WTRU may determine the resource grant type (e.g., default CG, or CG+DG) for transmitting the PDU set based on the PDU set info received from an application/higher layers, configuration info received from the network on CG resource configuration, and min/max payload size threshold values.

If the total PDU set payload size is more than a maximum PDU set payload size threshold for CG, or if the expected PDU set latency is more than the PDU set delay budget), the WTRU may trigger SR and/or BSR to request for DG resources for transmitting additional PDUs (e.g., PDUs that may not fit within CG resources). The WTRU may send an (e.g., explicit or implicit indication) on the payload sizes and/or a remaining latency associated with the additional PDUs that are unable to be accommodated within CG resources.

The WTRU may update a counter on the number of times the WTRU used additional resources to (e.g., for) the default CG. If the additional DG request counter is greater than or equal to a maximum counter limit, the WTRU may indicate to the gNB to switch to the second CG configuration with more resources (e.g., than originally allocated) due to a consistent surge in traffic. The WTRU may send the indication via a UCI piggybacked on UL data, or UCI on PUCCH, MAC CE, or RRC signaling.

If the total PDU set payload size is less than the maximum PDU set payload size threshold for CG, and if the expected PDU set latency is less than or equal to the PDU set delay budget), the WTRU may determine the number of excess CG occasions and/or the payload sizes of PDUs of PDU set that may be sent over the remaining CG occasions based on the PDU set delay budget and the configuration info.

The WTRU may update a counter on the number of times it released CG occasions while using the default CG. If the releasing CG occasions counter is greater than or equal to the maximum counter limit, the WTRU may indicate to the gNB to switch to the third CG configuration with less resources due to a consistent decrease in traffic. The WTRU may send the indication via a UCI piggybacked on UL data or a UCI on PUCCH, MAC CE, or RRC signaling.

The WTRU may reset an additional DG request counter and a releasing CG occasions counter to zero at a period of time (e.g., in terms of multiples of CG occasions), so that the counters can represent the recent status of the quantity of UL traffic.

In examples, a WTRU may determine adjustments to CG resources based on variable PDU characteristics associated within a PDU set. In such examples, a WTRU may determine one or more adjustments to CG configurations based on PDU set information (e.g., PDU payload sizes), resource configuration information, and/or a configured payload size threshold for using CG configurations during UL transmissions. In examples, parameters associated with adjustable CG configurations may be similar to a default CG configuration where allocated periodic and semi-persistent radio resources may be available to such WTRU for a certain duration. In examples, e.g., with adjustable CG configurations, allocated PUSCH resources in a period may be adjusted by increasing or decreasing a number and/or number of resources (e.g., PUSCH slots, PRBs, MSC indexes, etc.) to match variable PDUs and/or PDU sets transmitted by such WTRU. Such WTRU may determine, based on a PDU set traffic information (e.g., PDU set traffic information received from an application and/or higher layer), to use a default CG configuration or to request an allocation or more (or less) PUSCH slots to some CG occasions. An example for determining adjustments to CG configurations to use during UL transmission of one or more PDU sets is provided.

A WTRU may receive configuration information from a network (e.g., gNB, etc.) including one or more adjustable CG resource configurations (e.g., parameters of adjustable CG resource configuration may include a default number of PUSCH slots per occasion, default periodicity value, and default number of CG occasions), and minimum and/or maximum threshold values indicating PDU set payload size per CG occasion that may be transmitted using default CG resources.

Such WTRU may receive a first PDU subset including or more PDUs associated with a PDU set from an application and/or higher layer (in some examples also including a traffic pattern information associated with the PDU set). In examples, such first subset may include a PDU set information (e.g., in one or more PDU headers) associated with the PDU set (e.g., total PDU set payload size, total number of PDUs in PDU set, PDU set delay budget, etc.).

Such WTRU may transmit the PDU subset set using resources in a next CG occasion.

Such WTRU may determine CG resources that may be applied for transmitting the second PDU based on, e.g., the configuration information and/or traffic pattern information.

In examples where a total payload size of the second PDU subset exceeds the maximum PDU payload size per CG occasion threshold, such WTRU may determine a number of additional PUSCH slots per CG occasion that may be used for transmitting the second PDU subset. Such determination may be done, e.g., by such WTRU based on a difference between the total payload size of the second PDU subset and the maximum PDU payload size per occasion threshold, for example.

Such WTRU may transmit a request indication to the network to increase the number of PUSCH slots, in some examples by a determined additional number of PUSCH slots, for the following one or more CG occasions. Such request may be transmitted in UCI (e.g., SR), PUSCH (e.g., containing piggybacked UCI), UL MAC CE (e.g., BSR), RRC signaling/message, or other suitable channel, for example. In examples, such request may be transmitted multiplexed with the first PDU subset using a CG occasion. In examples, such request may be transmitted as a separate indication before or after transmitting the first PDU subset. In examples, such WTRU may indicate whether the requested change of resources (e.g., increase) is temporary (e.g., for next CG occasion) or semi-persistent (e.g., one or more CG occasions).

Such WTRU may monitor for an indication (in some examples within a time window) for receiving a response to such request.

Such WTRU may WTRU may receive a response indicating an increase of allocated PUSCH slots and/or resources for following one or more CG occasions. Such indication may be received in DCI (e.g., PDCCH, flag), PDSCH (e.g., containing piggybacked DCI), HARQ feedback (e.g., for the previous transmission of PDUs of PDU set), WUS, DL MAC CE or RRC signaling/message, for example.

Such WTRU may transmit the second PDU subset upon reception of the second PDU subset from the application and/or higher layer, using the received allocation of adjustable CG resources (e.g., increased PUSCH slots) in the next CG occasion.

In examples where a total payload size of the second PDU subset is below the minimum PDU payload size per CG occasion threshold, such WTRU may determine a number of excess PUSCH slots per CG occasion that may not be used for transmitting the second PDU subset based, e.g., on the difference between the payload size of the second PDU subset and the minimum PDU payload size per occasion threshold.

Such WTRU may transmit a request to decrease and/or skip the number of PUSCH slots (in some examples by the determined excess number of PUSCH slots) for following one or more CG occasions. Such a request may be transmitted in UCI (e.g., SR), PUSCH (e.g., containing piggybacked UCI), UL MAC CE (e.g., BSR), or RRC signaling/message, for example. In examples, such request may be transmitted multiplexed with the first PDU subset using a CG occasion. In examples, such request may be transmitted as a separate indication before or after transmitting the first PDU subset. In an example, such WTRU may indicate whether the requested change of resources (e.g., decrease/skip) is temporary (e.g., for next CG occasion) or semi-persistent (e.g., one or more CG occasions).

Such WTRU may receive an indication indicating a decrease and/or skipping of some PUSCH resources for following one or more CG occasions. Such indication may be received in DCI (e.g., PDCCH, flag), PDSCH (e.g., containing piggybacked DCI), HARQ feedback (e.g., for the previous transmission of PDUs of PDU set), WUS, DL MAC CE or RRC signaling/message, for example.

Such WTRU may transmit the second PDU subset upon reception of the second PDU subset from application and/or higher layer using the available CG resources in the next CG occasion.

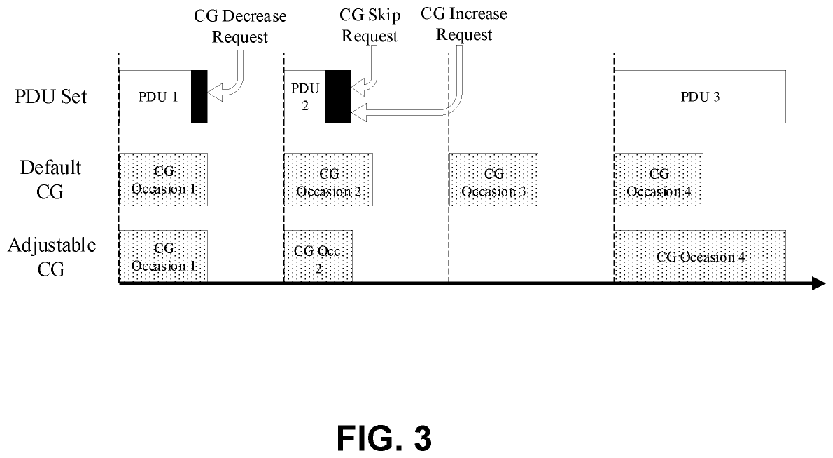

With reference to FIG. 3, FIG. 3 illustrates how an example WTRU (here, a UE) may determine changes to an adjustable CG configuration (e.g., to decrease and/or skip or to increase CG resources in different occasions) based on variable PDU characteristics in the PDU set (e.g., variable PDU set payload size) during UL transmissions. In some examples, a default CGH configuration may not allow such changes to the CG resources.

In examples, a WTRU may determine to skip one or more of assigned CG resources based on variable PDU characteristics associated with a PDU set, resource configuration information, and a configured jitter threshold. Such WTRU may use PDU set traffic information received from an application and/or higher layer to decide whether to skip one or more of the allocated CG occasions if an expected arrival of a subset of incoming PDUs is exceeds a configured jitter threshold (e.g., jitter is greater than the length of multiple CG occasions). An example for determining to skip one or more assigned CG occasions is provided.

A WTRU may receive configuration information from a network (e.g., gNB), including one or more default CG resource configurations (e.g., parameters of adjustable CG resource configuration may include an initial/default number of PUSCH slots per occasion, initial periodicity value, and initial/default number of CG occasions), a jitter threshold (e.g., time duration for determining whether the PDUs associated with a PDU set may be transmitted using CG occasions or may be skipped). Such sitter threshold may be indicated, e.g., in terms of number of PUSCH slots and/or CG occasions.

Such WTRU may receive a first PDU subset associated with a PDU set from an application and/or higher layer (in some examples also including a traffic pattern information of the PDU set. For example, the first PDU subset may include information (e.g., in PDU header) on an expected arrival time of a second PDU subset associated with the PDU set.

Such WTRU may transmit the first PDU subset using resources in a next CG occasion.

Such WTRU may determine jitter (e.g., in terms of number of PUSCH slots and/or CG occasions) associated with the second PDU subset based on, e.g., the traffic pattern information (e.g., expected arrival time of PDUs) and/or configuration information.

For examples where the determined jitter associated with the second PDU subset set exceeds the jitter threshold, such WTRU may transmit a request to the network to decrease and/or skip some PUSCH slots or CG occasions. In examples, such CG occasions may correspond with the determined jitter for transmitting the second PDU subset. Such request may be transmitted in UCI (e.g., SR), PUSCH (e.g., containing piggybacked UCI), UL MAC CE (e.g., BSR), or RRC signaling/message, for example. Such request may be transmitted multiplexed with the first PDU subset using a CG occasion or may be transmitted as a separate request before or after transmitting the first PDU subset set. In examples, the WTRU may indicate whether the requested change of resources (e.g., decrease and/or skip) is temporary (e.g., for next CG occasion) or semi-persistent (e.g., for one or more CG occasions).

In examples, such WTRU may transmit the second PDU subset upon receipt of the second PDU subset from application and/or higher layer, using available CG resources in the next CG occasion.

The WTRU may be configured to indicate unused (e.g., skipped) UL CG occasions based on traffic characteristics.

The WTRU may determine to skip one or more of the assigned CG resources based on the information on PDU set characteristics (e.g., PDU payload size, PDU set delay budget) and resource configuration information. The CG resources that may be skipped or unused by the WTRU may include at least one of the following: PUSCH occasions, slots, PRBs per PUSCH occasion, and/or CG cycles/periods. The WTRU may use the PDU set traffic information received from the application/higher layer to decide whether to skip the one or more allocated CG resources if the WTRU is expected not to use the one or more CH resources (e.g., PUSCH occasions) to send the UL data. An example technique applied by WTRU for determining the skipping of CG occasions may include the following.

The WTRU may receive configuration info from the gNB, including one or more of the following.

The configuration information may include one or more default or initial CG resource configurations. The parameters associated with a CG resource configuration, that may be configured in the WTRU may be adjusted and may include at least one of the following: start slot/symbol offset, number of PUSCH occasions per slot, number of symbols per PUSCH occasion, number of PUSCH occasions per CG cycle/period, number of slots per CG cycle/period, number of CG cycles/periods per CG configuration, and CG periodicity value. The configuration information may include CG skipping configuration information (e.g., a resource difference threshold associated with early and/or late skipping).

The configuration info may include a configuration associated with an early skipping approach that may be used by the WTRU by indicating to the gNB about skipping of an unused CG resource (e.g., one or more PUSCH occasions) during early occasions/slots associated with a CG cycle/period. The WTRU may send the indication of an unused CG resource associated with one or more PUSCH occasions starting from the first PUSCH occasion in a slot, for example. The indication may indicate an unused PUSCH occasion (e.g., from the second occasion to the last occasion). The indication may be sent by the WTRU on a per slot basis or per group of slots basis. The indication may be used to assist the gNB for reallocating a skipped or unused CG resource (e.g., PUSCH occasions or PRBs) to other WTRUs.

The WTRU may transmit, to the gNB (e.g., a network node), an availability indication, and the availability indication may indicate a number of available PUSCH occasions in the CG period. Available PUSCH occasions may be available to be skipped (e.g., skipped PUSCH occasions). Available PUSCH occasions and skipped PUSCH occasions may be used interchangeably as described herein.

The configuration info may include a configuration associated with a late skipping approach, which may be used by the WTRU to indicate to the gNB about skipping CG resources (e.g., one or more PUSCH occasions) during later occasions/slots associated with a CG cycle/period. The WTRU may send an indication of an unused CG resource associated with one or more PUSCH occasions starting from the nth PUSCH occasion in a slot, for example. The indication may indicate an unused PUSCH occasions from the n+1 occasion to the last occasion. The indication may be sent by the WTRU on a per slot basis or per group of slots basis. The late skipping indication may be sent along with the latest PDUs of the PDU set or subset after determining that the PDUs of the PDU set or subset were transmitted.

The WTRU may receive a first subset consisting of one or more PDUs of a PDU set from the application/higher layer, along with traffic info of the PDUs/PDU sets. In examples, the first subset consisting of one or more PDUs of the PDU set may include information (e.g., in the PDU header) on the expected/actual size of the PDU set.

Information associated with the PDU set may include a total payload size and a delay bound of the PDU set. The WTRU may determine, based on the total payload size and the delay bound of the PDU, the estimated payload size of the second subset of PDUs of the PDU set and the estimated arrival time of the second subset of PDUs of the PDU set.

The WTRU may determine the number of CG resources (e.g., PUSCH occasions, CG slots/cycles/periods) to send the PDU set using information about the CG configuration obtained from the gNB and PDU set size information obtained from the application layer.

The WTRU may receive, from the network node, the configuration information indicating a delay threshold and a configured grant (CG) configuration including a number of PUSCH occasions in a CG period. The WTRU may receive, from the application layer (e.g., an application), a first subset of PDUs of a PDU set and information associated with the PDU set.

The PDU set may be associated with the CG period. The WTRU may determine an estimated payload size of a second subset of PDUs of the PDU set and an estimated arrival time of the second subset of PDUs of the PDU set. The WTRU may determine, based on a payload size of the first subset of PDUs and the estimated payload size of the second subset of PDUs, a first group of CG PUSCH occasions associated with the first subset of PDUs and a second group of CG PUSCH occasions associated with the second subset of PDUs.

The WTRU may determine an available CG PUSCH occasion between the first and second group of CG PUSCH occasions based on an arrival time of the first subset of PDUs and the estimated arrival time of the second subset of PDUs on a condition that a difference between the estimated arrival time of the second subset of PDUs and the arrival time of the first subset of PDUs is greater than the delay threshold. The WTRU may transmit, to a network node, information indicating at least the available CG PUSCH occasion, the first group of CG PUSCH occasions, and the second group of CG PUSCH occasions.

The WTRU may determine to send an indication to skip unused CG resources (e.g., PUSCH occasions, CG slots/cycles/periods) that are expected not to be used (e.g., to be unused). In examples, the WTRU may perform one or more of the following.

The WTRU may assign a temporary or semi-persistent status to the available CG PUSCH occasion based on network traffic characteristics, and the temporary status may indicate applicability to a next PUSCH occasion, and a semi-persistent status may indicate applicability to one or more PUSCH occasions.

If the number of allocated PUSCH occasions minus the number of used PUSCH occasions plus the number of expected retransmissions is greater than the difference threshold for early skipping, the WTRU may transmit an early CG skipping indication to the gNB to skip PUSCH occasions in one or more slots. Early CG skipping may be used when the difference between the allocated and used PUSCH occasions is large (e.g., above a threshold). The request indication may be transmitted in UCI (e.g., SR), PUSCH (e.g., containing piggybacked UCI), UL MAC CE (e.g., BSR), or RRC signaling/message, for example. The UCI may correspond to a CG-UCI or a new UCI (e.g., a UCI corresponding to a non-CG UCI). The indication may be transmitted by multiplexing it along with the first subset of the PDU set using a CG resource or may be transmitted as a separate indication before/after transmitting the first subset of the PDU set, for example. In examples, the WTRU may indicate whether the requested skipping of resources/PUSCH occasions is temporary (e.g., for the next PUSCH occasion or CG slot/cycle/period) or semi-persistent (e.g., one or more PUSCH occasions or CG slots/cycles/periods).

The WTRU may estimate available CG resources based on a difference between the number of PUSCH occasions in the CG period and a sum of used PUSCH occasions in the first group and the second group of CG PUSCH occasions.

The WTRU may indicate the CG skipping in multiple formats. The WTRU may send an offset value to indicate to the gNB that the WTRU may skip the PUSCH occasions in a slot starting after this offset value. The WTRU may send a bitmap vector to indicate the skipped and/or used upcoming PUSCH occasions or slots. A value ‘1’ in the bitmap may indicate the PUSCH occasions or slots that may be unused. The WTRU may send the number of PUSCH occasions to be skipped. The gNB may determine which occasions to be skipped based on SRs from a (e.g., other) WTRU in the network, for example. The WTRU may monitor a PDCCH after transmissions for receiving a skipping confirmation indication from the gNB. The reception of an indication (e.g., in PDCCH) by the WTRU may confirm the number of PUSCH occasions that may be skipped, for example. The WTRU may indicate the n unused PUSCH occasions (e.g., n=1) in an indication (e.g., in CG-UCI or new UCI) sent to the gNB. The indication may be transmitted along with the data in the first PUSCH occasion. In an example, the WTRU may indicate the k unused PUSCH occasions from the last PUSCH occasion in a slot or CG cycle/period (e.g., in the indication sent to the gNB).

The WTRU may transmit the information in a WTRU indication that is multiplexed with the first subset of the PDU set or transmitted separately from the first subset of the PDU set.

The WTRU may encode the information indicating the available CG PUSCH occasion using either a bitmap vector or an offset value. The bitmap vector may indicate a status of upcoming PUSCH occasions or slots, and the offset value may indicate a delay for the WTRU to skip PUSCH occasions.

If the number of allocated PUSCH occasions minus the number of used PUSCH occasions plus the number of expected retransmissions is greater than the difference threshold for late skipping, the WTRU may send PDUs from the PDU set or a subset using PUSCH occasions until it receives an ACK for the last PDU to be transmitted during the allocated set of CG occasions.

The WTRU may transmit a late CG skipping indication to the gNB to skip PUSCH occasions in one or more slots. The request indication may be transmitted in UCI (e.g., SR), PUSCH (e.g., containing piggybacked UCI), UL MAC CE (e.g., BSR), or RRC signaling/message, for example. The indication may be transmitted by multiplexing it along with the first subset of the PDU set using a CG resource or may be transmitted as a separate indication before/after transmitting the first subset of the PDU set, for example. The WTRU may indicate whether the requested skipping of resources/PUSCH occasions is temporary (e.g., for a next PUSCH occasion or CG slot/cycle/period) or semi-persistent (e.g., one or more PUSCH occasions or CG slots/cycles/periods).

The WTRU may indicate the skipping of unused PUSCH occasions in (e.g., multiple) formats. The WTRU may use similar formats used to indicate early skipping. The WTRU may send a flag to indicate the skipping of the upcoming one or more PUSCH occasions or CG slots, from the nth PUSCH occasion onwards in a slot or from the nth PUSCH occasion until the start of the next set of PUSCH occasions or CG slots according to the CG configuration. The WTRU may indicate n unused PUSCH occasions in the indication (e.g., in CG-UCI or new UCI) sent to the gNB. The indication may be transmitted along with the data in the mth PUSCH occasion (e.g., m=n−1) or the last PUSCH occasion in a slot or a CG period/cycle.

The WTRU may receive, from the network node, an availability confirmation from the network node. The availability confirmation may indicate an approved number of PUSCH occasions to be available within the CG period.

The WTRU may decide to skip slots in a current or following CG cycle(s)/periods(s). The WTRU may determine that it does not (e.g., need to) use (e.g., all) the allocated resources (e.g., slots) in a given CG slot/cycle/period. The WTRU may indicate to the gNB to partially skip (e.g., some of) the resources (e.g., PUSCH occasions, or PRBs) of one or more CG slot/cycle/period by informing the gNB of the number of resources (e.g., PUSCH occasions) to be skipped and for how many CG slot/cycle/period.

The WTRU may be configured to indicate unused UL CG occasions based on HARQ feedback. The WTRU may determine whether to skip one or more of the assigned CG resources (e.g., PUSCH occasions) based on HARQ feedback. If the WTRU receives multiple NACKs in previous CG slots/periods/cycles, the WTRU may not indicate unused CG resources or PUSCH occasions and/or may not indicate that the WTRU will not (e.g., need to) use additional CG resources. The resources may be used retransmissions. If a WTRU has a low number of NACKs in previous transmissions, it may indicate to the gNB about potential unused CG resources or PUSCH occasions. An example technique applied by the WTRU for determining the skipping of CG occasions based on HARQ feedback may include the following.

The WTRU may receive configuration info from the gNB, including one or more default CG resource configurations (e.g., parameters of an adjustable CG resource configuration may include an initial/default number of PUSCH occasions per slot, initial periodicity value, and initial/default number of CG occasions). The configuration may include CG skipping configuration information (e.g., a number of NACKs maximum threshold for triggering CG skipping). The WTRU may update a NACK counter for a NACK it receives (or after ACK timeout) for a non-ACKed PDU(s). The WTRU may determine to send an indication to skip CG resources (e.g., PUSCH occasions) that are expected not to be used.

In examples, the WTRU may perform one or more of the following. If the number of allocated PUSCH occasions is greater than the number of used PUSCH occasions and the NACKs counter is less than the maximum number of NACKs threshold), the WTUR may transmit a CG skipping indication to the gNB to indicate the unused PUSCH occasions. The request indication may be transmitted in UCI (e.g., SR), PUSCH (e.g., containing piggybacked UCI), UL MAC CE (e.g., BSR), or RRC signaling/message, for example. The indication may be transmitted by multiplexing it along with the first subset of the PDU set using a CG resource or may be transmitted as a separate indication before/after transmitting the first subset of the PDU set, for example. The WTRU may indicate whether the requested skipping of resources/PUSCH occasions is temporary (e.g., for a next PUSCH occasion, or a CG slot/cycle/period) or semi-persistent (e.g., one or more PUSCH occasions or CG slots/cycles/periods).

The WTRU may indicate the CG skipping in multiple formats. First, the WTRU may send an offset value to indicate to the gNB that the WTRU may skip the PUSCH occasions starting after this offset value. Second, the WTRU may send a bitmap vector to indicate the skipped and used upcoming PUSCH occasions. The WTRU may send the number of PUSCH occasions to be skipped. The gNB may determine which occasions to be skipped based on SRs from a (e.g., another) WTRU in the network, for example. In the latter case, the WTRU may need to monitor a PDCCH after transmissions for receiving a skipping confirmation indication from the gNB. The reception of an indication (e.g., in PDCCH) by the WTRU may confirm the number of PUSCH occasions that may be skipped, for example.

A WTRU may be configured to receive HARQ feedback for XR data transmitted using CG resources. In an example, the WTRU may determine whether/when to monitor for a DL indication (e.g., in PDCCH) indicating the HARQ feedback based on the HARQ configuration used when transmitting XR data with one or more PUSCH occasions per slot/period with CG. For example, the WTRU may be configured to receive HARQ feedback when configured with CG resources for transmitting XR data in UL. When configured with HARQ, the WTRU may assume reception of HARQ feedback (ACK/NACK) in a time instance after transmitting XR data using CG resources. When XR data (e.g., PDU sets) is transmitted with one or more PUSCH occasions in a CG configuration, the HARQ feedback may be received in time instances (e.g., occasions, slots, cycles/periods) associated with one or more of the following.

The instances may be associated with being in an occasion or slot, after a PUSCH occasion. For example, the HARQ feedback associated with the data sent in a PUSCH occasion may be received in the kth DL occasion or slot (e.g., k=1) occurring after the PUSCH occasion. For example, when data is transmitted in the first PUSCH occasion in a slot, the associated HARQ feedback may be received in the nth DL occasion (e.g., n=1, 2, 3, 4) after the UL PUSCH occasion.

The instances may be associated with being in an occasion or slot, after n PUSCH occasions. For example, the HARQ feedback associated with the data sent in n PUSCH occasions may be received in the first occasion or slot (e.g., in DL) occurring after the n PUSCH occasions. For example, when data is transmitted in a slot comprising of 4 PUSCH occasions, the associated HARQ feedback may be received in the nth DL slot (e.g., n=1, 2, 3, 4) after the UL slot. The instances may be associated with being in a slot or period/cycle, after n slots. For example, the HARQ feedback associated with the data sent in n slots (e.g., n=1) may be received in the kth DL slot (e.g., k=1) occurring after the n slots. For example, when data is transmitted in n slots over one or more periods/cycles, wherein a slot may comprise of one or more PUSCH occasions, and wherein a period/cycle may comprise of one or more slots, the associated HARQ feedback may be received in the nth DL slot (e.g., n=1, 2, 3, 4) after the n UL slots.

The WTRU may receive the HARQ feedback on the basis of the transmission of a transport block (TB), where such transmission may be associated with one or more HARQ processes (e.g., with a HARQ process ID). In an example, when transmitting the XR data in one or more TBs, wherein the TBs may be transmitted in one or more PUSCH occasions or slots, the WTRU may initiate one or more HARQ processes. The WTRU may select a HARQ process ID, for example, from a configured ID pool or preconfigured by the network, and indicate the selected HARQ process ID in the control information (e.g., in PUCCH) associated with the PUSCH carrying the TB. When receiving the HARQ feedback, the WTRU may receive an indication of the HARQ process (ID) to which the feedback may be referring to, for example. If the WTRU transmits one or more TBs using n PUSCH occasions, wherein the PUSCH occasions may be associated with one or n HARQ processes, the WTRU may receive feedback for the HARQ processes (e.g., a TB).

The WTRU may receive the HARQ feedback associated with XR data/TBs transmitted in one or more PUSCH occasions in any of the following: PDCCH in DCI, PDSCH, MAC CE or RRC signaling, for example. Such HARQ feedback may be received on the basis of one or more of the following: per TB, per PUSCH basis, per UL slot, per set of TBs, per set of PUSCHs and set of UL slots. Such HARQ feedback may be received in a bitmap, for example, wherein a bit in the bitmap may correspond to the ACK/NACK feedback for a TB transmitted in a PUSCH occasion, for example. For example, a bitmap with a length of 8 bits may correspond to 8 PUSCHs carrying one or more TBs. The bit ‘1’ may indicate an ACK and the bit ‘0’ may indicate a NACK for the TB transmitted in the associated PUSCH occasion. The HARQ feedback may be received implicitly in PDCCH. When the WTRU receives PDCCH in a DL occasion/slot associated with the PUSCH/HARQ process, wherein the PDCCH may contain an UL DG grant, the WTRU may assume a NACK indication for the associated TB. The UL grant may be used to retransmit the TB. When the WTRU does not receive PDCCH in an expected occasion/slot, the WTRU may assume the ACK indication for the associated TB, for example.

In examples, a WTRU may determine whether to use a CG config with higher reliability (e.g., low MCS, high number of PRBs per slots and/or occasions, etc.) based on a status of a previous PDU set transmission. Such WTRU may use PDU set traffic information received from an application and/or higher layer to decide whether to skip one or more of the allocated CG occasions if an expected arrival of a subset of incoming PDUs is exceeds a configured jitter threshold (e.g., jitter is greater than the length of multiple CG occasions). An example for determining adjustments to CG configurations to use during UL transmission of one or more PDU sets is provided. In examples, transmitting one or more of the PDUs in the PDU set using more reliable resources (such as when the link conditions are not favorable for using the default CG resource configuration (e.g., high MCS, low number of PRBs per slot/occasion)) resource usage efficiency may be improved and meeting a delay bound associated with the PDU set may be achieved. Such WTRU may use the PDU set traffic information received from the application and/or higher layer to decide whether to keep using a default CG configuration or to trigger a request for using a CG configuration with higher reliability, for example. An example for determining whether to use a CG config with higher reliability is provided.

A WTRU may receive a configuration information, including a first CG configuration (e.g., default CG configuration parameters may include one or more high MCS values/indexes (e.g., aggressive MCS) and a low number of PRBs per slot/occasion). Such first CG configuration parameters may be intended for improving resource usage efficiency during transmissions, for example.

Such configuration information may include a second CG configuration information (e.g., high reliability CG configuration parameters may include one or more high MCS values/indexes and high number of PRBs per slot and/or occasion). Such second CG configuration parameters may be intended for trading off resource usage efficiency for improving reliability during transmissions, for example.

Such configuration information may include a remaining latency threshold (e.g., corresponding to the latency value for transmitting a of the remaining PDUs associated with the PDU set). The threshold may be used for determining whether to switch between using the first CG configuration and the second CG configuration, for example.

Such configuration information may include a maximum retransmission threshold per PDU (e.g., used for determining the maximum retransmission for a PDU associated with the PDU set for switching between using the first CG configuration and the second CG configuration).

Such WTRU may receive one or more PDUs associated with a PDU set from the application and/or higher layer (in some examples also including a PDU set delay budget (e.g., in a header of one or more PDUs associated with the PDU set)).

Such WTRU may use the first CG configuration for transmitting in UL at least some of the PDUs associated with the PDU set.

Such WTRU may receive feedback (e.g., HARQ ACK/NACK feedback), indicating status of UL transmission of the PDUs associated with the PDU set. For example, the feedback indication may be received at the granularity of per PDU, per subset of PDUs associated with the PDU set, and/or per PDU set.

Such WTRU may continue using the first CG configuration for retransmitting the one or more PDUs (e.g., when receiving NACK feedback indication), up to the maximum retransmission threshold.

In examples where a number of received NACKs exceeds the maximum retransmission threshold, such WTRU may determine a remaining latency for transmitting the one or more remaining PDUs associated with the PDU set based on PDU set delay budget and time incurred for transmissions and/or retransmissions of a previously transmitted PDUs associated with the PDU set. In examples, such WTRU may switch to using the second CG configuration based on a change in importance of PDUs (e.g., after receiving multiple NACKs, the importance of the remaining PDUs may increase and allow to switch to a higher reliability CG configuration).

In examples where a determined remaining latency is below a remaining latency threshold, such WTRU may select the second CG configuration for transmitting in UL the remaining PDUs associated with the PDU set.

In examples, such WTRU may send an indication of switching to the second CG configuration. Such an indication may be transmitted in UCI (e.g., SR), PUSCH (e.g., containing piggybacked UCI), UL MAC CE (e.g., BSR), or RRC signaling/message, for example.

In examples, Such WTRU may transmit the remaining PDUs associated with the PDU set using the second CG configuration, possibly upon receiving a confirmation indication (e.g., from gNB) (e.g., in DCI, MAC CE).

In examples where an ACK feedback indication is received at or before reaching maximum retransmission threshold, such WTRU may continue using the first CG configuration for transmitting the one or more remaining PDUs associated with the PDU set.

In examples, a WTRU may determine to use SR resources associated with different LCHs according to a change in priority of PDUs associated with a PDU set. In examples, while transmitting PDUs associated with the PDU set in UL, a change in the priority of some PDUs (e.g., due to approaching a deadline) may result in the WTRU selecting SR resources from one or more LCHs that may be different than the LCHs mapped to the already sent PDUs associated with the PDU set. The SR resources of different LCHs may be accessed and/or triggered for transmitting request for resource grants (e.g., DG resources) for sending the remaining PDUs by a PDU set delay bound, for example. In examples, LCP restrictions associated with one or more LCHs may be relaxed for a duration, for example LCP restrictions applicable to high priority LCHs. During relaxed LCP restrictions, a WTRU may use low latency SR resources associated with low-latency LCHs of other traffic (e.g., URLLC) to meeting the deadline and/or delay bound of the PDU set associated with XR traffic, for example. An example for determining to use SR resources associated with different LCHs according to a change in priority of PDUs is provided.

WTRU may receive a configuration information including a first LCH configuration (e.g., default LCH configuration associated with XR traffic intended to support high throughput and/or mid-level latency), a second LCH configuration (e.g., low latency LCH configuration associated with low latency traffic intended to support low throughput and/or ultra-low latency), one or more SR resources and/or configurations associated with the first LCH configuration and the second LCH configuration, and a remaining latency threshold (e.g., corresponding to a latency value for transmitting the PDUs associated with the PDU set). In examples, the threshold may be used to determine whether to switch between using the first LCH configuration and the second LCH configuration for accessing the SR resources.

Such WTRU may receive a first PDU subset including of one or more PDUs associated with the PDU set from the application and/or higher layer, (in some examples also including a traffic pattern information of the PDU set).

For example, the first PDU subset may include information (e.g., in a PDU header) on a second PDU subset including one or more PDUs associated with the PDU set (such information including, e.g., total PDU set payload size, total number of PDUs in PDU set, PDU set delay budget, etc.).

The first PDU subset may be mapped to the first LCH configuration, in examples.

Such WTRU may trigger SR associated with the first LCH configuration. For example, such WTRU may explicitly or implicitly indicate the traffic information associated with the PDU set (e.g., PDU set delay budget, remaining latency for sending the remaining PDUs of PDU set, PDU set size, number of PDUs) in SR and/or in BSR upon triggering the SR. Such an indication may be transmitted in UCI (e.g., SR), PUSCH (e.g., containing piggybacked UCI), UL MAC CE (e.g., BSR, new BSR), or RRC signaling/message, for example.

Such WTRU may transmit the first PDU subset using DG resource allocation upon triggering SR/BSR.

Such WTRU may receive a second PDU subset including one or more PDUs associated with the PDU set from the application and/or higher layer (in some examples also including a traffic pattern information of subsequent PDUs/PDU sets).

Such WTRU may determine remaining latency for transmitting the second PDU subset based on the PDU set delay budget and the time incurred for transmissions and/or retransmissions of the first PDU subset.

In examples where a determined remaining latency is below the remaining latency threshold, the WTRU may trigger SR associated with the second LCH configuration. For example, such WTRU may explicitly or implicitly indicate the selection and/or the cause for selection of SR resources in the second LCH (e.g., due to meeting the configured remaining latency threshold). Such WTRU may, in examples, explicitly and/or implicitly indicate traffic information associated with the second PDU subset (e.g., PDU set delay budget, remaining latency for sending remaining PDUs, amount of PDU set size for remaining PDUs, number of remaining PDUs) in SR and/or in BSR upon triggering the SR. Such an indication may be transmitted in UCI (e.g., SR), PUSCH (e.g., containing piggybacked UCI), UL MAC CE (e.g., BSR, new BSR), or RRC signaling/message, for example. Such WTRU may transmit the second PDU subset using a received DG resource allocation (e.g., received from gNB) (e.g., in DCI).

In examples where the determined remaining latency exceeds the remaining latency threshold, the WTRU may trigger SR associated with the first LCH configuration. Such a WTRU may transmit the second PDU subset using received DG resource allocation received.

The WTRU may be configured to support dynamic adaptation of SPS/CG parameters.

In an example, the WTRU may be configured with an initial/default number of PDSCHs per SPS occasion/slot for DL reception of periodic XR traffic (e.g., PDU sets/PDU set groups). The initial number of PDSCHs may be determined by the WTRU and/or network based on an XR traffic pattern (e.g., such as periodicity, expected number of PDUs per PDU set and PDU set QoS (e.g., PSDB), etc., for example). The WTRU may send in a dynamic indication (e.g., in RRC signaling, MAC CE, or UCI) to the base station (e.g., to request to change the number of PDSCHs (e.g., to increase or decrease by x number) per SPS occasion/slot), for example, when detecting a triggering condition as may be described herein. The WTRU may receive a dynamic indication (e.g., in RRC signaling, MAC CE, or DCI) from the base station, indicating a change (e.g., an increase or decrease by x number) to a number of PDSCHs per SPS occasion/slot, for example. In an example, the WTRU may be configured (e.g., initially configured) with a high number of PDSCHs per SPS occasion/slot. The WTRU may then receive an indication (e.g., in a MAC CE, DCI or non-scheduling DCI) from the base station indicating to skip one or more of the PDSCHs when receiving DL data, for example.

In an example involving periodic UL transmissions, the WTRU may be configured with an initial/default number of PUSCHs (e.g., per CG occasion/slot) for supporting periodic XR traffic in UL. The TB size or number of TBs carrying the PDUs/PDU sets may be larger or smaller than the initial number of PUSCHs, and the WTRU may send an indication to the base station (e.g., in RRC, MAC CE, UCI, or in the first PUSCH) and request to change the number of PUSCHs per CG occasion/slot. The WTRU may send the indication to increase by a certain number of PUSCHs, for example, when one or more of the following is true: the number of PUSCHs is insufficient or the PDUs/PDU sets may not be delayed to the next CG occasion. The PDU set may be transmitted using fewer than the initial number of PUSCHs, and the WTRU may send an indication (e.g., MAC CE, UCI) to the base station to skip one or more (e.g., some) of the PUSCHs, for example. The WTRU may receive an indication from the base station, indicating the increase/decrease the number of PUSCHs per CG occasion/slot.

In an example, the WTRU may be configured with one or more start time offset values associated with SPS and/or CG occasions/slots. The start time offset values may be used for time shifting (e.g., advancing/delaying by a number of slots) with respect to the SPS and/or CG occasions, for example. The WTRU may send an indication (e.g., in RRC, MAC CE or UCI) to the base station for indicating the changes to the start time offset of any of the CG or SPS occasions, based on arrival time of one or more PDUs/PDU sets detected/measured by the WTRU, for example. The WTRU may receive an indication (e.g., in RRC, MAC CE, DCI) from the base station for indicating changes (e.g., time shift) to the start time offset of any of the CG or SPS occasions, for example. For minimizing overhead, an indication may be used by the WTRU for indicating to the base station to change the start time offset of multiple CG and/or SPS occasions/slots. The indication may indicate the number of CG and/or SPS occasions to be time shifted and the value of time shift, for example. Similarly, the WTRU may receive from the base station an indication (e.g., a single indication) indicating the time shift to multiple CG and/or SPS occasions/slots.

The WTRU may be configured to support and/or trigger dynamic activation/deactivation of multiple CG configurations. In an example, the WTRU may be configured with multiple active CG configurations corresponding to (e.g., different) traffic patterns of flows supported by the WTRU. For example, when performing UL transmissions of data associated with a flow (e.g., a first flow) with small payload sizes and a flow (e.g., a second flow) with large payload sizes, the WTRU may be configured to use at least two CG configurations, where a CG configuration may be configured with a low/high number of PUSCHs per occasion/slot. In an example, the WTRU may be configured to use multiple active CG configurations, where a CG configuration may consist of a (e.g., different) set of parameters (e.g., a different number of PUSCHs per CG occasion/slot, different start time offset per CG occasion/slot). The WTRU may send an indication (e.g., in RRC, MAC CE or UCI) to the base station for requesting/indicating to dynamically activate/deactivate one or more CG configurations (e.g., based on arrival time and/or payload sizes of one or more PDUs/PDU sets in UL, for example).

In an example, the WTRU may be configured with multiple CG configurations (e.g., first and second CG configs) with different parameters (e.g., periodicity, number of PUSCHs per occasion) for transmitting in UL the different types of PDU sets (e.g., I-frames or P/B frames). Data may be transmitted in UL (e.g., PDU set carrying I-frame data) using an initial/first CG configuration with an initial/default number of CG occasions, and the high layers (e.g., higher layers) in the WTRU may determine the traffic pattern for the UL data in a next set of one or more CG occasions (e.g., based on GOP structure and frame rate). Such information on the traffic pattern may be used by the WTRU for identifying (e.g., other/second) one or more CG configurations (e.g., with a different periodicity or a different number of OPUSCHs per occasion) that may match with the traffic pattern of (e.g., a next) UL data (e.g., next PDU set). The WTRU may send an indication (e.g., in RRC, MAC CE, UCI) to the base station on the identified CG configurations (e.g., IDs of CG configurations) that may be used for transmitting the next UL data. The WTRU may receive from the base station an indication (e.g., in RRC, MAC CE or DCI) to (e.g., dynamically) activate/deactivate the CG configurations which the WTRU may use when performing the UL transmissions.

The WTRU may be configured to support (e.g., dynamic) grants with multiple PUSCH allocations. In an example, the WTRU may be configured to receive in one or more indications from the base station the dynamic resource grant allocations for (e.g., multiple) PUSCHs with (e.g., different) configurations (e.g., different MCS and/or different number of PRBs per PUSCH). The indication may be received by the WTRU in RRC signaling, MAC CE, DCI, non-scheduling DCI or in PDSCH, for example. The indication may indicate a (e.g., different) number of PUSCHs per allocation, the resource grant allocation pattern for recurring allocations (e.g., dynamic resource grant allocations over multiple slots), and a duration for a resource grant allocation pattern.

The WTRU may (e.g., for receiving the indication on dynamic resource grant allocations for multiple PUSCHs with different configurations/allocations) send information on the traffic pattern in the UL. Such information may be sent by the WTRU in one or more of RRC, MAC CE (e.g., new or enhanced BSR), UCI, or PUSCH, for example. Such information on the traffic pattern sent by the WTRU may include any of the following: a number of PDUs of PDU set, payload size of PDU set, number of (e.g., dependent) PDU sets in a PDU set group, expected arrival time of PDUs in one or more PDU sets, delay bound/PSDB of one or more PDU sets, timing information (e.g., remaining time) for transmitting one or more PDUs/PDU sets, etc. The WTRU may receive from the base station an indication (e.g., in RRC, MAC CE, DCI) indicating the one or more parameters including a (e.g., recurring dynamic) resource grant allocation pattern that may be aligned with the time instances/slots when the PDUs/PDU sets may be expected to arrive at WTRU and be ready for UL transmission, for example.

Techniques as described herein may support power savings when handling PDU sets. In examples, the WTRU may send assistance/status information associated with handling XR traffic and PDU sets to network for enabling adaptive scheduling with power saving. In an example, the WTRU may send information associated with supporting power saving subject to the QoS requirements of the XR application to the network (e.g., for enabling the network to have awareness of XR application in order to support more power saving for the UE). The information associated with application-awareness and/or QoS may be sent by the WTRU to network as one or more of the following message types: a preferred configuration information (e.g., preferred CG configuration mode in UL); a status information/indication (e.g., battery level status); a measurement/status reports (e.g., channel/link measurements, buffer occupancy measurements); or request/response messages).

The WTRU may be configured to receive configuration/assistance information/indications from the network for supporting adaptive scheduling with power saving. The information associated power saving that may be received by the WTRU from network may include one or more of the following: CG configuration information (e.g., default CG and power-saving CG mode configuration information), including one or more of periodicity, start offset, duration, BWPs, numerology/SCS values, number of PRBs per slot, number of occasions/periods/cycles, number of PUSCH slots per occasion, maximum number/duration/length of PUSCH, antenna ports, or transmit power; counter thresholds (e.g., thresholds of the number of NACKs to enable using power-saving CG configurations); timers (e.g., timers to start counting NACKs before checking the eligibility for switching to the power-saving CG configuration(s); or threshold values (e.g., for example, the WTRU battery level threshold associated with the measurement of energy stored in the WTRU battery below which the WTRU may be triggered to take actions for power saving).

The WTRU may determine whether to use a CG configuration with low power based on the status of PDU set transmission and WTRU power state. In an example, the WTRU may determine whether to transmit a subset of one or more PDUs of a PDU set using a CG resource configuration with low power (e.g., low number of PRBs per slot/occasion, low transmit power) based on the status of transmission of a previous subset of the PDU set (e.g., remaining latency, PDU set delay budget, number of NACK feedback receptions) and/or WTRU power state (e.g., WTRU battery level). In this case, the WTRU may determine to use a power-saving CG configuration for improving energy efficiency while meeting the delay bound associated with the PDU set. The WTRU may use the PDU set traffic information received from the application/higher layer to decide whether to keep using the default CG configuration or to trigger a request for using a CG configuration with lower power consumption, for example.

In an example, the WTRU may monitor the performance of UL transmissions by counting the number of NACKs or monitoring the channel quality. The number of NACKs may be lower than a certain threshold, and there may be an opportunity to meet the XR-specific QoS requirements while using a low-power CG configuration. Checking the eligibility for low-power CG configuration may be triggered by the WTRU battery level status. The WTRU may determine whether the QoS requirements (e.g., PDU set delay budget) of the XR application may be met using the low-power CG configuration by determining the expected latency for PDU (or PDU set) transmission. The WTRU may request/select the low-power CG config (e.g., low number of PRBs or low transmit power) if the PDUs (or PDU set) may be transmitted withing the PDU delay budget.

An example applied by the WTRU for determining a suitable CG resource configuration for transmission of PDUs of a PDU set may include one or more of the following. The WTRU may receive configuration information (e.g., from a gNB), including: a first CG configuration (e.g., default CG configuration parameters may consist of a high number of PRBs per slot/occasion and high transmit power. Such configuration parameters may be intended for improving capacity), for example; a second CG configuration (e.g., low power CG configuration parameters may consist of a low number of PRBs per slot/occasion and low transmit power. Such configuration parameters may be intended for power saving), for example; or a number of NACKs threshold per PDU (e.g., used for determining the maximum number of retransmissions for a PDU in a PDU set for enabling the request for switching to the second CG configuration).

The WTRU may receive one or more PDUs (e.g., of a PDU set) from the application/higher layer, (e.g., along with an indication of a PDU set delay budget (e.g., in a header of one or more PDUs of a PDU set).

The WTRU may use the first CG configuration for transmitting in UL. For example, The WTRU may use the first CG configuration to transmit at least some of the PDUs of the PDU set using the UL.

The WTRU may receive a feedback indication (e.g., HARQ ACK/NACK feedback from the gNB), indicating the status of UL transmission of the PDUs of a PDU set (e.g., the feedback indication may be received at the granularity of per-PDU, per-subset of PDUs in PDU set and/or per-PDU set).

The WTRU may continue using the first CG configuration for transmitting the one or more PDUs (e.g., when receiving NACK feedback indication) until a timer expires (e.g., a duration of time elapses or passes) to check the number of NACKs received against the number of NACKs threshold (e.g., or WTRU is in low battery level state). As used herein, a timer may be a duration of time, an amount of time that may elapse, and/or the like.

If the number of received NACKs is less than a number of NACKs threshold, the WTRU may determine the remaining latency for transmitting the one or more remaining PDUs of the PDU set based on a PDU set delay budget and the time incurred for transmissions and/or retransmissions of previously transmitted PDUs of a PDU set. In an example, the WTRU may select/switch to using the second CG configuration based on the opportunity to save power while meeting the QoS requirements of the XR application.

If the determined remaining latency is less than a PDU set delay budget. The WTRU may select the second CG configuration for transmitting in UL the remaining PDUs of the PDU set, for example. The WTRU may send an indication (e.g., to the gNB) for indicating the selection/switching to the second CG configuration. Such an indication may be transmitted in one or more of UCI (e.g., SR), PUSCH (e.g., containing piggybacked UCI), UL MAC CE (e.g., BSR), or RRC signaling/message, for example. The WTRU may transmit the remaining PDUs of the PDU set using second CG configuration, possibly upon receiving a confirmation indication (e.g., from a gNB in DCI, MAC CE). The WTRU may continue using the first CG configuration for transmitting the one or more remaining PDUs of the PDU set.

The WTRU may be configured to support dynamic adaptation of connected-mode discontinuous reception (CDRX) parameters. In an example, the WTRU may be configured to (e.g., dynamically) adjust the CDRX cycle lengths, active/ON time duration in one or more CDRX cycles, including the current and next cycles. For example, the adjustment to the active/ON time may be done by the WTRU by increasing/decreasing the ON duration, using multiple/additional/fewer ON durations, or increasing/decreasing inactive timer for receiving the PDUs in one or more PDU sets. The traffic arriving in DL may have a high number of PDUs and strict PSDB, and the length of the current ON duration applied at the WTRU may be extended or additional ON durations may be triggered for receiving the PDUs in the PDU set, for example. The PDU set may have a low number of PDUs which may be delivered using a shorter ON/active time, and the current ON duration at WTRU may be shortened/reduced (e.g., possibly by a preconfigured value).

In an example, the WTRU may be configured with one or more sets of CDRX cycle length values comprising (e.g., different) CDRX cycles. For example, a first set may consist of 16 ms, 16 ms, and 17 ms; a second set may consist of 16 ms, 17 ms, and 17 ms; and a third set may consist of 8 ms, 9 ms, and 9 ms. In an example, the WTRU may be configured with different ON duration length values, different start offsets for a fixed ON duration value, and/or inactivity timer values when configuring the CDRX configuration. The WTRU may receive a dynamic indication (e.g., in MAC CE or DCI) during the current active/ON time, for example, when detecting a mismatch between a traffic pattern and the configured CDRX parameters. The WTRU may apply the indicated changes to the CDRX parameters (e.g., may use a new set of CDRX cycle lengths, use new ON duration, and/or activate multiple/additional ON durations) when receiving the dynamic indication from the base station, for example. For example, an (e.g., single) indication (e.g., a single MAC CE, or DCI) may be used for adapting the length of the active/ON duration or triggering additional ON durations for multiple CDRX cycles, possibly for reducing the signaling overhead. When receiving the dynamic indication, the WTRU may adjust the CDRX according to the indicated parameters for receiving the PDU sets over one or more cycles, for example.

In an example, the WTRU may adjust or assist in adjusting the start offset time of the CDRX active/ON duration for addressing jitter in DL/UL and/or to align with the XR traffic pattern (e.g., arrival of the PDUs/PDU sets). In an example, the presence of jitter may cause the arrival of PDUs within a PDU set (e.g., intra-PDU set jitter) and across different PDU sets (e.g., inter-PDU set jitter) to be delayed/advanced when arriving at the WTRU in UL and/or at the base station in DL. For intra-PDU set jitter, the PDU set boundary corresponding to the arrival time of the first PDU and last PDU of a PDU set may vary instead of arriving periodically in a burst aligned with the frame generation periodicity, for example. For inter-PDU set jitter, the arrival time of different PDU sets may vary from one another instead of following the frame generation periodicity, for example.

In an example, the adjustment to the start offset time of the CDRX active time may include advancing or delaying the corresponding offset time slot. For transmission of UL data, the WTRU may determine the adjustments to the start offset time (e.g., number of slots to be advanced or delayed) based on the arrival time of one or more PDUs or PDU sets. The WTRU may send an indication to the base station (e.g., in RRC signaling, MAC CE, UCI, or PUSCH) on the adjustment value such that the base station may be aware of the changes to the active time duration from transmitting DL signals/channels (e.g., PDCCH, and/or PDSCH), for example. For example, the adjustment indication sent by the WTRU may include any of the ID of CDRX configuration, number of time slots to be advance/delayed, index/ID of the start offset adjustment values (e.g., preconfigured in UEs), number of CDRX occasions for which the adjustment to the start offset may apply, start cycle of when the adjustment may apply (e.g., current CDRX cycle or next CDRX cycle) etc. The WTRU may receive an indication from the base station (e.g., in RRC, MAC CE, DCI, or PDSCH) indicating acknowledgement/rejection of the adjustment to the start offset, for example. For DL transmissions, the WTRU may receive from the base station an indication indicating the adjustment to the start offset time to the CDRX active/ON time duration, for example. Similar to the UL case, the indication received by the WTRU may indicate any of the following: ID of CDRX configuration, number of time slots to be advance/delayed, index/ID of the start offset adjustment values (e.g., preconfigured in UEs), number of CDRX occasions for which the adjustment to the start offset may apply, start cycle of when the adjustment may apply (e.g., current CDRX cycle or next CDRX cycle) etc. For example, the dynamic indication received by the WTRU (e.g., in DCI) during the active/ON duration in the current CDRX cycle may indicate the preconfigured start offset value to apply for the next CDRX cycle.

The WTRU may be configured with multiple CRDX configurations, and an indication (e.g., a single indication) may be sent by the WTRU (e.g., single UL MAC CE, or single UCI) or received by the WTRU (e.g., single UL MAC CE, or single DCI) for indicating the adjustment to the start offset time for multiple CDRX configurations, which may minimize overhead. The indication may contain the IDs/indexes of the one or more CDRX configuration (e.g., different CDRX configurations) or the ID/index of the CDRX configuration group consisting of one or more CDRX configurations, for example.

In an example, (e.g., possibly corresponding to split rendering applications (e.g., VR, AR)), the WTRU may transmit pose and/or video traffic in UL, and in response, may receive the pre-rendered video traffic in the DL. To assist in providing an adequate user experience, after sending the UL data, the DL data may be received within a maximum RTT latency. The WTRU may be both the source and destination of the UL and DL traffic, and the higher layers in the WTRU may determine the traffic pattern expected in DL (e.g., payload sizes of DL PDU sets, arrival time of DL traffic), for example, based on the traffic transmitted in UL and knowledge of RTT latency. When identifying that the configured CDRX parameters (e.g., active/ON duration, start offset) may not be suitable for handling the traffic pattern expected in DL, the WTRU may send an indication to the base station (e.g., in RRC signaling, MAC CE, UCI) to request certain adaptation to the CDRX parameters conjured at the UE. For example, the WTRU may send a request/indication (e.g., in RRC signaling, MAC CE or UCI) for extending the active/ON duration or adjusting the start offset time (e.g., by advancing/delaying by a number of time slots) of the active/ON duration in next CDRX cycle for receiving the DL traffic within the RTT latency. The WTRU may receive an indication from the base station (e.g., in RRC, MAC CE, DCI, or PDSCH) indicating acknowledgement/rejection of the adjustment to the CDRX parameters (e.g., active/ON duration, start offset), for example.

The WTRU may be configured to support and/or trigger dynamic activation/deactivation of multiple CDRX configurations/parameters. In an example, the WTRU may be configured to support a set of one or more active CDRX configurations, which may be used simultaneously for receiving DL traffic and/or for transmitting UL traffic. The CDRX configurations may be associated with one or more traffic flows supported by WTRU during DL reception and/or UL transmission, for example. For example, when handling a flow with small payload sizes and a flow with large payload sizes, dedicated CDRX configurations with short/long ON durations per cycle may be used instead of a single CDRX configuration with high periodicity and/or long ON duration for supporting multiple flows.

In an example, the WTRU may send a request to the base station (e.g., in RRC signaling, MAC CE or UCI) to (e.g., dynamically) activate/deactivate one or more CDRX configurations based on a detection of one or more triggering events/conditions (described in another section of this disclosure). For example, the WTRU may send an indication to trigger or assist to dynamically activate/deactivate multiple CDRX configurations at once for matching with the UL and/or DL traffic patterns of different flows and for reducing overhead. The WTRU may receive an indication (e.g., in RRC signaling, MAC CE or DCI) from the base station indicating the activation/deactivation of one or more CDRX configurations. The indication or a bitmap received by WTRU from the base station may contain the ID/index of the CDRX configurations that may be activated/deactivated, for example. The WTRU may be configured with a CDRX configuration group including one or more CDRX configurations along with the CDRX configuration group ID/index. The indication received by WTRU may contain the CDRX configuration group ID, for example.

In an example, the WTRU may have a first CDRX configuration activated and may send a request to activate the second, third, and fourth CDRX configurations, and deactivate the first CDRX configurations when detecting (e.g., some) triggering conditions. The WTRU may receive from the base station an indication indicating the activation of the second CDRX and third CDRX configuration, and a deactivation of the first CDRX configuration, for example.

In an example, the WTRU may be configured with one or more CDRX configurations with different parameters (e.g., periodicity, ON duration, start offset) associated with handling of different types of PDU sets (e.g., I-frames or P/B frames). When receiving a DL data (e.g., PDU set carrying I-frame data) with a first CDRX configuration, the WTRU may determine the traffic pattern for the DL data in a next cycle (e.g., based on GOP structure and frame rate). The WTRU may then identify one or more CDRX configurations that may match with the traffic pattern of the DL data in the next cycle based on the determined traffic pattern. The WTRU may send an indication (e.g., in RRC signaling, MAC CE, or UCI) to the base station on the identified CDRX configurations (e.g., IDs/indexes of CDRX configurations or ID/index of CDRX configuration group) that may be used for receiving the DL data in the next cycle. The WTRU may receive from the base station the indication to dynamically activate/deactivate the one or more CDRX configurations (e.g., IDs) or the CDRX configuration group (e.g., group ID) in the WTRU for receiving the DL traffic.

In an example, the WTRU may be configured with multi-stage CDRX configuration, which may consist of one more parameter sets (e.g., cycle duration, periodicity, ON/active duration, start offset) that may be used for receiving/transmitting XR traffic (e.g., PDU sets, PDU set group). For example, the WTRU may be configured with a first stage CDRX comprising of a first stage parameter set (e.g., first cycle duration, first ON duration, and first periodicity) and a second stage CDRX comprising of a second stage parameter set (e.g., first cycle duration, first ON duration and first periodicity). A multi-stage CDRX may be configured, and the second stage CDRX and/or the second stage parameter set may be applied within the ON/active duration of the first stage CDRX, for example. In an example, when using the multi-stage CDRX configuration, the WTRU may receive one or more DL signals (e.g., PDCCH, PDSCH) and/or perform UL transmissions (e.g., PUCCH, PUSCH) in the time slots of the ON/active durations associated with the second stage CDRX (e.g., which may be configured to be active/aligned within the ON/active duration of the first stage CDRX). In an example, the WTRU may receive a DL signal (e.g., PDCCH, PDSCH) and/or perform UL transmissions (e.g., PUCCH, PUSCH) in the time slots of the ON/active durations associated with the second stage CDRX (e.g., which may be configured to be outside of the ON/active duration of the first stage CDRX, possibly overlapping with one or more slots associated with the sleep duration of the first stage CDRX).

In an example, the WTRU may be configured with first and second stage CDRX configurations and/or first and second stage parameter sets (e.g., in RRC signaling). The first stage CDRX and/or first stage parameter set may be activated by default, when receiving the configuration information, for example. The WTRU may send a request/indication to the base station (e.g., in RRC signaling, MAC CE, or UCI) to activate the second stage CDRX and/or second stage parameter set (IDs/indexes) when detecting one or more triggering conditions (e.g., detection of jitter when transmitting PDU sets is above/below a threshold value), for example. The WTRU may receive an indication (e.g., in RRC signaling, MAC CE, or DCI) from the base station indicating the activation/deactivation of the second stage CDRX and/or second stage parameter set, for example. The WTRU may receive the activation/deactivation indication from the base station indicating to activate/deactivate the second stage CDRX and/or second stage parameter set (e.g., possibly due to detection of jitter in the DL) for example.

The WTRU may be configured to support dynamic adaptation of PDCCH monitoring. In an example, the WTRU may be configured to support dynamic adaptations to PDCCH monitoring behavior when handling variable XR traffic patterns and jitter. For example, when receiving the last PDU of a PDU set or a PDU set group (e.g., data burst), the WTRU may receive an indication from the base station (e.g., in MAC CE, DCI) indicating the PDCCH skipping duration until the arrival of the next PDU set/PDU set group. An example of this may be applied when handling traffic patterns with a low number of PDUs/PDU sets or a low duration for DL reception, where the WTRU may be transitioned to sleep mode for long (e.g., longer) durations until the arrival of the next PDU set/PDU set group. In an example, the WTRU may be configured with one or more PDCCH monitoring skipping durations (e.g., IDs/indexes), possibly aligned with the XR traffic pattern parameters (e.g., periodicities, frames per second, number of flows, jitter range). The WTRU may (e.g., dynamically) receive the one or more indications, indicating the PDCCH monitoring skipping durations (e.g., IDs/indexes) to apply when receiving the DL traffic, for example.

WTRU-initiated PDCCH monitoring behavior adaptation may be provided. The WTRU may send an indication to the base station (e.g., in RRC signaling, MAC CE, UCI) indicating the PDCCH monitoring skipping duration the WTRU may intend to use for receiving the one or more DL transmissions. The indication may contain one or more PDCCH monitoring skipping durations (e.g., IDs/indexes), and a number of cycles for the skipping durations may apply. Such parameters associated with the PDCCH monitoring skipping durations (e.g., skipping duration values, IDs/indexes) may be preconfigured in the WTRU, for example.

The WTRU may determine the PDCCH monitoring skipping duration to indicate to the base station, based on the knowledge of RTT latency and association between UL and DL traffic available from higher layers at the WTRU, for example. Jitter in a network may impact the arrival of DL traffic, and the WTRU may account for the jitter range when determining the PDCCH monitoring skipping duration (e.g., possibly based on jitter range (e.g., standard deviation with respect to periodic occasions when the traffic may be expected to arrive) configured in the WTRU). In an example, the WTRU may account for the jitter by initiating PDCCH monitoring in a sparse search space set group (SSSG) (e.g., possibly prior to sending the PDCCH monitoring skipping duration indication to base station), and switch to a dense SSSG at the end of the PDCCH monitoring skipping duration.

In an example, where HARQ retransmissions in UL may be supported by the WTRU after receiving an indication from the base station to skip PDCCH monitoring, the WTRU may start skipping PCDDH monitoring from the next time slot onwards. This may result in a reduction in the PDCCH monitoring skipping duration and/or a shorter time available for the WTRU to operate in sleep/low power operation. For example, to minimize the possibility for receiving retransmissions and/or to extend sleep duration at the WTRU, the WTRU may be configured to receive the last PDU of PDU set/PDU set group with one or more robust MCS (e.g., QPSK, 16-QAM) schemes before receiving the indication for PDCCH monitoring skipping. The WTRU may be configured to go into sleep mode directly when the determining from the PDCCH/DCI that the transport block (TB) carrying the last PDU of the PDU set/PDU set group may be transmitted using (e.g., robust) MCS and/or when receiving the PDCCH monitoring skipping indication. Alternatively, the WTRU may be configured to receive the PDCCH monitoring skipping indication in a different indication than the DCI so that the WTRU may not monitor for PDCCH associated with retransmissions and may enter into sleep mode soon after reception of a last PDU of a PDU set/burst. For example, the WTRU may be configured to receive the indication for PDCCH monitoring skipping in PDSCH (e.g., along with the data or last PDU), MAC CE, or a non-scheduling DCI.

In an example, the WTRU may be configured to support dynamic adaptations to PDCCH monitoring behavior when handling variable XR traffic patterns and jitter. For example, when receiving the last PDU of a PDU set or a PDU set group (e.g., data burst), the WTRU may receive an indication from the base station.

A WTRU may be configured to switch between using single and multiple CDRX configurations.

In examples, the WTRU may be configured to switch between using one or multiple active CDRX configurations while receiving DL traffic and/or for transmitting UL traffic based on known or predicted traffic arrival rates, payload size, and delay budgets of multiple traffic flows. When handling multiple traffic flows with stringent delay budgets, the WTRU may be configured to support multiple CDRX configurations for different traffic flows simultaneously. If one or more traffic flows have relaxed delay requirements, they may have the tolerance to wait until the ON time of the next CDRX cycle. The WTRU may support a single CDRX configuration by aggregating data from multiple traffic flows.

In examples, the WTRU may be configured to activate or deactivate two CDRX configurations for two DL traffic flows. The first traffic flow may have a large payload size, strict delay budget, and low arrival rate (e.g., video with low frame rate).

The first traffic flow may be associated with a CDRX configuration with a long CDRX cycle length and a long ON time that is enough for receiving DL data within the strict delay budget. The second traffic flow may have a small payload size, high arrival rate, and a strict delay budget. The WTRU may be configured to activate the second CDRX configuration matching the traffic flow of the second traffic flow, e.g., with a short ON time and frequent (e.g., more frequency) cycles.

The second traffic flow may have a small payload size, high arrival rate, and a relaxed delay budget. The WTRU may receive the data of the first and the second traffic flows combined during the ON time of the first CDRX cycle.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-20. (canceled)

21. A wireless transmit/receive unit (WTRU) comprising a processor:
the processor configured to:
receive, from a network node, configuration information that indicates a window length associated with a bitmap;
determine that a first bit in the bitmap is associated with a first upcoming CG-PUSCH occasion and that a second bit in the bitmap is associated with a second upcoming CG-PUSCH occasion, wherein a bit value of 1 in the bitmap indicates that an upcoming CG-PUSCH occasion is unused; and
transmit the bitmap, wherein the bitmap comprises an indication that indicates that an upcoming corresponding CG-PUSCH occasion is unused, and wherein the bitmap is included in uplink control information (UCI) that is multiplexed into a current CG-PUSCH transmission.

22. The WTRU of claim 21, wherein the configuration information further indicates a plurality of parameters of a CG-PUSCH configuration, and wherein the plurality of parameters of the CG-PUSCH configuration comprises a number of PUSCH occasions per period.

23. The WTRU of claim 21, wherein the processor is further configured to determine that a third bit in the bitmap is associated with a third upcoming CG-PUSCH occasion, wherein the third bit has a value of 0, and wherein the third bit having the value of 0 indicates that the third upcoming CG-PUSCH occasion is used.

24. The WTRU of claim 21, wherein the processor is further configured to:
receive information that indicates an expected size of a data payload; and
determine the bitmap based on the expected size of the data payload.

25. The WTRU of claim 21, wherein the processor is further configured to:
determine that an early skipping threshold is met; and
based on the determination that the early skipping threshold is met, set one or more bits in the bitmap to indicate an unused CG-PUSCH occasion.

26. The WTRU of claim 21, wherein the UCI is multiplexed with a first subset of a PDU set.

27. The WTRU of claim 21, wherein the processor is further configured to:
determine whether late skipping is used; and
set a fourth bit in the bitmap corresponding to a CG-PUSCH occasion occurring in a CG cycle or period.

28. A method for a wireless transmit/receive unit (WTRU), the method comprising:
receiving, from a network node, configuration information that indicates a window length associated with a bitmap;
determining that a first bit in the bitmap is associated with a first upcoming CG-PUSCH occasion and that a second bit in the bitmap is associated with a second upcoming CG-PUSCH occasion, wherein a bit value of 1 in the bitmap indicates that an upcoming CG-PUSCH occasion is unused; and
transmitting the bitmap, wherein the bitmap comprises an indication that indicates that an upcoming corresponding CG-PUSCH occasion is unused, and wherein the bitmap is included in uplink control information (UCI) that is multiplexed into a current CG-PUSCH transmission.

29. The method of claim 28, wherein the configuration information further indicates a plurality of parameters of a CG-PUSCH configuration, and wherein the plurality of parameters of the CG-PUSCH configuration comprises a number of PUSCH occasions per period.

30. The method of claim 28, wherein the method further comprises determining that a third bit in the bitmap is associated with a third upcoming CG-PUSCH occasion, wherein the third bit has a value of 0, and wherein the third bit having the value of 0 indicates that the third upcoming CG-PUSCH occasion is used.

31. The method of claim 28, wherein the method further comprises:
receiving information that indicates an expected size of a data payload; and
determining the bitmap based on the expected size of the data payload.

32. The method of claim 28, wherein the method further comprises:
determining that an early skipping threshold is met; and
based on the determination that the early skipping threshold is met, setting one or more bits in the bitmap to indicate an unused CG-PUSCH occasion.

33. The method of claim 28, wherein the UCI is multiplexed with a first subset of a PDU set.

34. The method of claim 28, wherein the method further comprises:
determining whether late skipping is used; and
setting a fourth bit in the bitmap corresponding to a CG-PUSCH occasion occurring in a CG cycle or period.
